(19) United States
(12) Patent Application Publication
(10) Pub. No.: US 2011/0096660 A1
(43) Pub. Date: Apr. 28, 2011

(54) HANDOVER PROCESSING METHOD, AND MOBILE TERMINAL USED IN THE METHOD

(75) Inventors: Shinkichi Ikeda, Kanagawa (JP); Takako Hori, Kanagawa (JP); Jun Hirano, Kanagawa (JP); Takashi Aramaki, Osaka (JP)

(73) Assignee: PANASONIC CORPORATION, Osaka (JP)

(21) Appl. No.: 12/999,959

(22) PCT Filed: Jun. 22, 2009
(86) PCT No.: PCT/JP2009/002832

§ 371 Date: Dec. 17, 2010

(30) Foreign Application Priority Data
Jun. 24, 2008 (JP) 2008-164256
Aug. 4, 2008 (JP) 2008-200522

(51) Int. Cl. H04W 36/00; H04L 12/26

(52) U.S. Cl. 370/225; 370/331

(57) ABSTRACT

Disclosed is a technique to provide a handover processing method to avoid a failure in both of the handovers and enables communication via an access network as a UE initiated handover target that is originally optimal. The handover processing method includes: a step where a mobile terminal (100) connected with a first access network (111) transmits a connection establishment request message requesting a connection with desired a second access network (113) to a base station (107) placed in a second access network; a step where the mobile terminal determines whether a predetermined event occurs or not; a step where, when the mobile terminal determines that the predetermined even occurs, generates a reconnection request message including first flag information to the second access network; and a step where the mobile terminal transmits the generated reconnection request message to the base station in the second access network.

### TECHNICAL FIELD

The present invention relates to a handover processing method of a mobile terminal in the case where a plurality of entities exists to control a couple of types of handover procedures for the mobile terminal and different types of handover are simultaneously initiated by the respective control entities, and relates to a mobile terminal and a connection management device used in the method.

### BACKGROUND ART

In a conventional mobile communication system, typical two types of handover methods are available, which is a terminal (or a user equipment (UE)) initiated handover and a network initiated handover. Firstly, an exemplary configuration of a mobile communication system is described referring to FIG. 1, and thereafter the respective handover methods are described. FIG. 1 illustrates an exemplary configuration of a conventional mobile communication system. As illustrated in FIG. 1, three different access domains (or access network systems) 111 to 113 are deployed so as to be connected with one core network 110. A mobile terminal 100 (hereinafter called a UE: User Equipment also) is able to connect with an appropriate access domain depending on its location.

In the core network 110, at least a packet gateway (PG) 104 and a Policy and Charging Rules Function (PCRF) 120 are deployed. The packet gateway 104 accommodates a UE 100 that is connected with the core network 110 via an access domain and performs connection management of the UE 100 with respect to a packet data network (PDN), while performing packet transfer therebetween. In 3rd Generation Partnership Project (3GPP) terminology, the packet gateway 104 is called a Packet Data Network Gateway (PDN-GW) or a Gateway CPRS Support Node (GGSN), for example. The PCRF 120 provides Quality of Service (QoS) policy information and accounting rule information regarding UE's PDN access to the packet gateway 104.

In each access domain, an access gateway (AG) 101 to 103 is deployed to accommodate the UE 100 at an IP layer. The UE 100 acquires an IP address and an IP prefix from an access gateway deployed in an access domain connected. Connection of the access gateway with the packet gateway 104 allows the UE 100 connecting with a non-3GPP access network such as a Wireless Local Area Network (WLAN) or a World interoperability for Microwave Access (WiMAX) to access a 3GPP service the core network 110 provides. The access gateway may be placed in the core network 110.

As a connection protocol between an access gateway and the packet gateway 104, PMIPv6 (Proxy Mobile IPv6), GTP (GPRS Tunnel Protocol) or the like is available. In 3GPP terminology, the access gateway is called a Serving Gateway (SGW), a Serving GPRS Support Node (SGSN), an evolved Packet Data Gateway (ePDG) or the like, which is placed in the core network 110. Herein, when Proxy Mobile IPv6 is used as an inter-gateway protocol, the access gateway is particularly called Mobility Anchor Gateway (MAG) or a SOW equipped with a MAG function, for example. In the case of Proxy Mobile IPv6 used, a Local Mobility Anchor (LMA) function is placed in the packet gateway (such as PDN-GW) 104.

Referring now to FIG. 13, a UE initiated handover is described below (refer to Non-Patent Document 1). When performing the UE initiated handover, it is required that a mobile terminal (UE) acquires a handover policy beforehand. The handover policy may be acquired by downloading from a network or retrieving from a SIM card, for example. The UE initiated handover is applied mainly to a handover between a 3GPP access and a non-3GPP access such as a wireless LAN hotspot or WiMAX.

Assume that the UE 100 already establishes a communication bearer via a 3GPP access (Step S13001). As a result of checking a measurement result of radio waves receivable from a non-3GPP access network with the handover policy, the UE 100 decides to perform a handover to the non-3GPP access (Step S13002), and starts an access authentication processing to use a 3GPP service via the non-3GPP access (Step S13003). When the access authentication is completed so that the connection is accepted (authentication of the UE 100 and access authorization to a service) to establish an access link, a connection establishment processing at layer 3 (IP layer) starts (L3 (Layer 3) attach trigger: Step S13004).

As a result, a node (e.g., a MAG) in the non-3GPP access network acquires QoS policy information and accounting rule information (e.g., a type of the access network and operator information) from the PCRF and configures them within the node (Gateway control session configuration request: Step S13005, Gateway control session configuration response: Step S13006). Subsequently, the MAG transmits a proxy BU (proxy binding update) to the PDN-GW (PDN gateway) 104 (Step S13007), and the PDN-GW 104 acquires the QoS policy information and the accounting rule information from the PCRF and configures them (Policy and accounting rule information request: Step S13008, Policy and Accounting information provisioning: Step S13009).

Further, the PDN-GW 104 authenticates the MAO (Step S13010). When these processes succeed, the PDN-GW 104 returns a proxy BA (binding ack) to the MAG (Step S13011), so that a PMIPv6 tunnel is configured between the MAG and the PDN-GW 104 (Step S13013). Receiving the proxy BA, the MAO transfers an IP prefix or an IP address allocated from the PDN-GW 104 to the UP 100 so as to complete the connection establishment processing at a L3 level (Step S13012). Then, finally, a 3GPP bearer resource of a handover source access is released to complete the UE initiated handover processing (3GPP EPS bearer resource release: Step S13014). Herein, the bearer resource assigned for the UE 100 may be released by the UE 100 or by the PDN-GW 104.

Referring next to FIGS. 18A and 18B, a network initiated handover is described below (refer to Non-Patent Document 3). In the network initiated handover, based on a measurement result of a surrounding wireless environment measured by the UE 100 (measurement report, described later), a network entity (e.g., a base station currently connecting) decides to perform a handover for the UE 100. Thus, there is no need for the UE 100 to acquire any handover policy. The network initiated handover is applied mainly to a handover within 3GPP access network systems or a handover between 3GPP accesses as well as applied to a handover within a non-3GPP access network systems or a handover between same type of non-3GPP access system.

The UE 100 has already established a communication bearer with a 3GPP access and reports successively intensity (radio field intensity or electric field intensity) of radio waves received from a surrounding base station and access network information to the network side. When a handover is decided to initiate based on the report (Step S18001), a base station (source eNodeB) 1802 connected with the UE 100 transmits a handover initiation request to a MME (Mobility Management Entity) 1801 (called a source MME also) accommodating the UE 100 at that time (Step S18002).

The MME 1801 transfers context of the UE 100 between the handover source access and the handover target access or reserves resources to be allocated to the UE 100 in the handover target access (Step S18003 to S18012). When these preliminary processes are completed, the MME 1801 instructs a base station 1802 to perform a handover (Step S18013). The base station 1802 transfers a handover initiation indication to the UE 100 (Step S18014). When a connection with a base station (target eNodeB) 1803 as a handover target is completed, the UE 100 transmits a handover confirmation message to the base station 1803 as the handover target (Step S18017).

In response to this, the base station 1803 as the handover target allocates actual resources to the UE 100 in the handover target access, and starts to transfer downlink packets (Steps S18018 to S18024). The following process is information updating processing conducted when a handover changes a tracking area where the UE 100 connects. A specific example of the area includes a paging area.

In the above-described FIGS. 18A and 18B, GTP can be used as a connection protocol between the Serving GW and the PDN-GW. On the other hand, FIG. 14 illustrates processing when Proxy MIPv6 can be used as a connection protocol (refer to Non-Patent Document 2), which is different from FIGS. 18A and 18B in that Proxy BU/BA is exchanged at (A), (B) of FIG. 18B and in that QoS policy information is acquired from the PCRF 120.

### PRIOR ART DOCUMENT

### Non-Patent Document

Non-Patent Document 1: Architecture enhancements for non-3GPP accesses (Release 8)”, 3GPP TS 23.402 V8.1.1 p. 108 March 2008.
Non-Patent Document 2: “Architecture enhancements for non-3GPP accesses (Release 8)”, 3GPP TS 23.402 V8.1.1 p. 55 Mar. 2008.
Non-Patent Document 3: “General Packet Radio Service (GPRS) enhancements for Evolved Universal Terrestrial Radio Access Network (E-UTRAN) access”, 3GPP TS 23.401 V8.1.0 p. 91 Mar. 2008.

These two types of handover processing methods are different in their control entities which have responsibility on handover decision. That is, in the UE initiated handover, a mobile terminal itself decides to perform a handover based on a measurement result of a surrounding access network environment measured by the mobile terminal, whereas in the network initiated handover, an entity on the network side (e.g., a base station currently connecting) decides to perform a handover based on a measurement result (measurement report) of a surrounding access network environment measured by the mobile terminal.

Therefore, particularly in a mobile terminal equipped with a communication interface for a connection with a 3GPP access and a communication interface for a connection with a non-3GPP access, these two types of handover processes may be generated at the same time. That is, after performing a UE initiated handover first, a network initiated handover is performed, or after performing a network initiated handover first, a UE initiated handover is performed afterwards.

Such different forms of handovers generated at the same time leads to a problem of a failure in updating a data path, resulting in failures in both handovers. This is described below in detail. In the system configuration of FIG. 1, it is assumed that an access domains (hereinafter called AD) 111 and 112 are 3GPP access domains (access networks), and a network initiated handover is applied to UE's movement between coverages of AD 111 and AD 112. An AD 113 is a non-3GPP access domain, and a UE initiated handover is applied to an AD 111-AD 113 handover and an AD 112-AD 113 handover. In FIG. 1, the UE 100 moves from the AD 111 to a border area in the AD 113 and the AD 112.

A first case is described, with reference to FIG. 15. Assume herein that the UE 100 establishes a bearer with a packet gateway (hereinafter called PG) 104 via a base station BS 105 and an access gateway (hereinafter called AG) 101 of the access domain AD 111 (Step S15001), and a packet addressed to the UE 100 is transferred correctly from the PG 104 via the AG 101 and the BS 105 in the AD 111 (packet reception: Step S15002). When the UE 100 decides to perform handover to the non-3GPP access domain AD 113, the UE 100 transmits an attachment event in a connection establishment request message to a BS 107 in the AD 113 (Step S15003).

The attachment event is transferred to the AG 103 with a MAG function, and the AG 103 transmits a proxy BU (proxy binding update) to the PG 104 (Step S15004). The PG 104 acquires QoS policy information from the PCRF 120 and configures it (QoS Provisioning: Step S15005), and updates a binding cache (BC) entry of the UE 100 for the AG 103 (Step S15006) and transmits a proxy BA (proxy binding ack) to the AG 103 (Step S15007).

Substantially at the same time as this, it is decided to perform a network initiated handover (Step S15009) because the UE 100 moves to an area possible to connect to a base station BS 106 of the access domain AD 112 (Step S15008). Then, an indication of the handover initiation indication (handover command) is transferred from the BS 105 to the UE 100, and receiving this, the UE 100 transmits a handover confirmation message (handover confirm) to the BS 106 as a handover target (Step S15010). The BS 106 transmits a path switching request to the AG 102, and receiving this, the AG 102 transmits a proxy BU to the PG 104 (Step S15011). The PG 104 acquires QoS policy information and configures it (QoS Provisioning: Step S15012), updates a binding cache (BC) entry for the AG 102 (Step S15014), and returns a proxy BA to the AG 102 (Step S15015).

As a result, the network initiated handover processing for the UE 100 from the AD 111 to the AD 112 is completed (Step S15016). At this time, the UE 100 has already received an attachment acknowledgement (Ack) as a response to the connection establishment request message (Step S15013), and recognizes that the UE initiated handover successfully done. Thus, the UE 100 transmits a resource release request to the AD 112 so as to disconnect from the 3GPP access as a handover source access, i.e., from the AD 112 (Step S15017). In response to this, a proxy BU is transmitted to the PG 104 (Step S15018), and a processing to release the resources which was allocated to the UE 100 in the AD 112 by the AG 102 and the PG 104 is performed (Step S15019), and the UE 100 is disconnected from the AD 112.

At this time, a conflict of system status would occur; the UE 100 keeps its connection via the AD 113, whereas the PG 104 does not have a data path to the UE 100 via the AD 113. This is substantially similar situation as a failure in the handover to the AD 113 because a data path updating request (proxy BU) due to the network initiated handover which is performed after establishment of a data path to the AD 113 (the above Step S15006) changes the data path to the AD 112 (the above Step S15014). While keeping a bearer at the AD 112, the UE 100 is able to transmit and receive a packet via the AD 112. However, the bearer at the AD 112 is intentionally released because the handover to the AD 113 was apparently successful, resulting in an inability for the UE 100 to receive a downlink packet. Herein, although an uplink packet may be transferred irrespective of a status of the PG 104, it may be impossible in some cases to communicate uplink packets similar to the transferring of downlink packets.

Note here that the PG 104 may voluntarily release a bearer resource for the AD 112. In this case, a resource is released not for the AD 112 but for the AD 113. This is because a valid data path at that time is directed to the AD 112 (the above Step S15014), but it was directed to the AD 113 at a stage before (the above Step S15006). Therefore, from the UE 100 perspective, the UE initiated handover that once successfully done results in a disconnection without reason. At this time, although a packet can be transmitted and received via the AD 112, a user cannot receive benefit from high-speed and broadband communication practically available over the non-3GPP access system, thus degrading user's convenience and benefit considerably. Further, in response to the apparently completing of the handover to the AD 113, the UE 100 may voluntarily disconnect a power source of a communication interface to connect with a 3GPP access domain. Thereby, the UE has to connect again via any access domain, which also causes user's inconvenience in addition to disconnection of a session so far.

Next, a second case is described below with reference to FIG. 16. Assume herein that the UE 100 establishes a bearer with a PG 104 via a BS 105 and an AG 101 in the access domain AD 111 (Step S16001), and the UE 100 can correctly receive a packet addressed to the UE 100 from the PG 104 via the AD 111 (packet reception: Step S16002). It is decided to perform a network initiated handover (Step S16007) because the UE 100 moves to a coverage of a base station BS 106 in the AD 112 (Step S16006). The UE 100 receives a handover command from the BS 105 in the AD 111, and transmits a handover confirmation message (handover confirm) to the BS 106 in the AD 112 (Step S16008).

In respect to the handover confirmation message, the BS 106 transmits a path switching request to the AG 102, and the AG 102 transmits a proxy BU to the PG 104 (Step S16009). The PG 104 acquires QoS policy information for the AD 112 from the PCRF 120 and configures it (QoS Provisioning: Step S16010). At the same time, when the UE 100 decides to perform a UE initiated handover to the AD 113 based on a wireless environment measurement result in the AD 113 and a handover policy, the UE 100 transmits an attachment event as a connection establishment request message to a BS 107 (Step S16003). The AG 103 receives via the BS 107 the connection establishment request from the UE 100, then transmits a proxy BU to the PG 104 (Step S16004).

At this time, however, since the PG 104 is on the process of the already received handover request for the UE 100 (i.e. handover to the AD 112), the PG 104 cannot accept a new handover request (i.e. handover to the AD 113). Thus, the PG 104 returns a NACK (Failed) to the AG 103 in the proxy BA (Step S16005). Thereby, the connection establishment request to the AD 113 is not accepted, and receiving a response of connection failure (attachment ack (Failed)) from the BS 107 (Step S16011), the UE 100 fails during the UE initiated handover procedure (UE initiated handover failure: Step S16015). At this time, the PG 104 updates a binding cache (BC) entry (Step S16012), and transmits a proxy BA to the AD 112 (Step S16013), whereby packet transmission/reception path via the AD 112 is available (path switching completion: Step S16014). However, a user cannot receive benefit from high-speed and broadband communication practically available over the non-3GPP access, thus degrading user's convenience and benefit considerably.

Herein, the attachment event at Step S16003 may be transmitted before performing of the network initiated handover (the above Step S16007). FIG. 17 exemplifies such a status, causing user's convenience considerably impaired like FIG. 16 because of a failure in connection with the AD 113. Resources in the a handover source access system is finally released in the UE initiated handover. Therefore, when the UE initiated handover occurs almost or exactly at the same time as the network initiated handover, the UE initiated handover may succeed finally. In terms of user's convenience and benefit, it is important to intentionally connect with the non-3GPP access system where capable of a high-speed and broadband communication are practically available.

### SUMMARY OF THE INVENTION

In view of the above-stated problems, it is an object of the present invention to provide a handover processing method, and a mobile terminal and a connection management device used in the method whereby, when detecting a network initiated handover being performed at the same time, an indication is issued so as to update a data path again, so that failures in both handovers are avoided, and communication is enabled via an access network as a UE initiated handover target that is originally optimal.

In order to fulfill the above-stated object, according to the present invention, a handover processing method for a mobile terminal is provided. The mobile terminal performs communication with a correspondent node via a communication network including a plurality of access networks including first and second access networks in a communication system, a plurality of control entities that control a handover of the mobile terminal existing in the communication system, each control entity performing a handover processing of the mobile terminal. The handover processing method includes the steps of: a step where the mobile terminal connecting with the first access network transmits a first connection establishment request message to a base station placed in the second access network, the first connection establishment request message requesting a connection with desired the second access network; a step where the mobile terminal determines whether a predetermined event occurs or not; a step where when the mobile terminal determines occurrence of the predetermined event, the mobile terminal generates a second connection establishment request message to the base station in the second access network, the second connection establishment request message including first flag information; and a step where the mobile terminal transmits the generated second connection establishment request message to the base station in the second access network. With this configuration, when detecting a network initiated handover performed at the same time, an indication is issued so as to update a data path again, so that failures in both handovers are avoided, and communication is enabled via an access network as a UE initiated handover target that is originally optimal. Herein, the first connection establishment request message corresponds to an attachment event message described later, and the second connection establishment request message corresponds to a re-attachment event message described later.

According to the present invention, a mobile terminal used in a handover processing method for the mobile terminal is provided. The mobile terminal performs communication with a correspondent node via a communication network including a plurality of access networks including first and second access networks in a communication system, a plurality of control entities that control a handover of the mobile terminal existing in the communication system, each control entity performing a handover processing of the mobile terminal. The mobile terminal includes: a message generation means that generates, when connecting with the first access network, a first connection establishment request message requesting a connection with desired the second access network; a transmission means that transmits the generated first connection establishment request message to a base station placed in the second access network; and a determination means that determines whether a predetermined event occurs or not. When it is determined that the predetermined event occurs, the message generation means generates a second connection establishment request message to the base station in the second access network, the second connection establishment request message including first flag information, and the transmission means transmits the generated second connection establishment request message to the base station in the second access network. With this configuration, when detecting a network initiated handover performed at the same time, an indication is issued so as to update a data path again, so that failures in both handovers are avoided, and communication is enabled via an access network as a UE initiated handover target that is originally optimal.

In the mobile terminal of the present invention, the predetermined event preferably includes a network initiated handover processing performed by a predetermined device of the communication network as a control entity before or after transmission of the first connection establishment request message, and the network initiated handover processing preferably includes a handover processing with another base station in the first access network or a handover processing to a third access network that is other than the first and the second access networks of the plurality of access networks. This configuration enables recognition of a network initiated handover being performed at the same time.

In the mobile terminal of the present invention, the predetermined event preferably further includes reception of a connection failure response message conveying a connection failure from the second access network. This configuration enables recognition of a UE initiated handover not being performed normally.

In the mobile terminal of the present invention, the network initiated handover processing by the predetermined device preferably is detected with occurrence of a handover processing between base stations in the first access network or with occurrence of a handover processing between the first access network and the third access network. This configuration enables recognition of a network initiated handover being performed.

In the mobile terminal of the present invention, the network initiated handover processing by the predetermined device preferably is detected with transmission by the mobile terminal of a report to the first access network, the report indicating examination of an access network environment surrounding the mobile terminal. This configuration enables recognition of a network initiated handover being performed.

In the mobile terminal of the present invention, the first flag information preferably urges to retransmit, to the base station in the second access network, a path switching message to the second access network. This configuration can perform a UE initiated handover.

In the mobile terminal of the present invention, the first flag information preferably further urges to use information generated based on the first connection establishment request message received before to process a predetermined processing other than retransmitting of the path switching message to the second access network. With this configuration, handover time can be reduced.

In the mobile terminal of the present invention, the message generation means preferably adds second flag information to the first connection establishment request message, the second flag information indicating a predetermined device in the second access network to store information generated based on reception of the first connection establishment request message before transmission of the path switching message to the second access network. With this configuration, a proxy BU processing only is performed when a reconnection request is generated, so that handover time can be reduced.

In the mobile terminal of the present invention, the generated information preferably includes information on an authentication processing result of the mobile terminal for connection with the second access network. With this configuration, handover time can be reduced.

In the mobile terminal of the present invention, after transmitting the second connection establishment request message to the base station in the second access network and a handover processing is performed to the second access network, when a network initiated handover processing performed by a predetermined device of the communication network as a control entity is performed again, the message generation means preferably includes third flag information in a second connection establishment request message requesting reconnection with the second access network, and the transmission means preferably transmits the second connection establishment request message including the third flag information to the base station in the second access network. This configuration allows a UE initiated handover to be performed normally.

In the mobile terminal of the present invention, the network initiated handover processing performed again by the predetermined device of the communication network as a control entity preferably is detected with reception of a packet via the first access network. This configuration enables recognition of a network initiated handover being performed.

In the mobile terminal of the present invention, the network initiated handover processing performed again by the predetermined device of the communication network as a control entity preferably is detected with reception of a connection failure response message conveying a connection failure a predetermined of times or more from the second access network. This configuration enables recognition of a UE initiated handover not being performed but a network initiated handover being performed.

In the mobile terminal of the present invention, the third flag information preferably instructs to stop the network initiated handover processing performed by the predetermined device of the communication network as a control entity. This configuration can stop performing a network initiated handover.

In the mobile terminal of the present invention, the transmission means preferably transmits the second connection establishment request message to the predetermined device via a predetermined authentication system. This configuration can stop performing a network initiated handover.

According to the present invention, a handover processing method for a mobile terminal is provided. The mobile terminal performs communication with a correspondent node via a communication network including a plurality of access networks including first and second access networks in a communication system, a plurality of control entities that control a handover of the mobile terminal existing in the communication system, each control entity performing a handover processing of the mobile terminal. The handover processing method includes the steps of: a step where the mobile terminal connecting with the first access network decides to perform handover to desired the second access network; a step where the mobile terminal determines whether a predetermined event occurs or not; a step where when the mobile terminal determines occurrence of the predetermined event, the mobile terminal generates a handover confirmation message including flag information; a step where the mobile terminal transmits the generated handover confirmation message to a base station in the first access network; a step where the mobile terminal receives a path switching completion notification message from a connection management device performing connection management of the mobile terminal, the path switching completion notification message generated based on the flag information and indicating that a path is switched by a network initiated handover processing that a predetermined device of the communication network performs as a control entity; and a step where the mobile terminal performs a handover to the second access network based on the path switching completion notification message. This configuration avoids a handover failure due to a collision of a network initiated handover processing and a UE initiated handover processing, so that communication is enabled via a desired access network as a UE initiated handover target. Herein, the connection management device corresponds to a packet gateway described later. The path switching completion notification message corresponds to a path switching completion notification or Binding Refreshment Request described later.

According to the present invention, a mobile terminal used in a handover processing method for the mobile terminal is provided. The mobile terminal performs communication with a correspondent node via a communication network including a plurality of access networks including first and second access networks in a communication system, a plurality of control entities that control a handover of the mobile terminal existing in the communication system, each control entity performing a handover processing of the mobile terminal. The mobile terminal includes: a decision means that decides to perform handover to desired the second access network; a determination means that determines whether a predetermined event occurs or not; a message generation means that, when it is determined that the predetermined event occurs, generates a handover confirmation message including flag information; a transmission means that transmits the generated handover confirmation message to a base station in the first access network; a reception means that receives a path switching completion notification message from a connection management device performing connection management of the mobile terminal, the path switching completion notification message generated based on the flag information and indicating that a path is switched by a network initiated handover processing that a predetermined device of the communication network performs as a control entity; and a processing means that performs a handover to the second access network based on the path switching completion notification message. This configuration avoids a handover failure due to a collision of a network initiated handover processing and a UE initiated handover processing, so that communication is enabled via a desired access network as a UE initiated handover target.

In the mobile terminal of the present invention, the predetermined event preferably includes a network initiated handover processing performed by a predetermined device of the communication network as a control entity, and the network initiated handover processing preferably includes a handover processing with another base station in the first access network or a handover processing to a third access network that is other than the first and the second access networks of the plurality of access networks. This configuration enables recognition of a network initiated handover being performed at the same time.

In the mobile terminal of the present invention, the network initiated handover processing by the predetermined device preferably is detected with reception of a handover command message transmitted from a base station in the first access network. This configuration enables recognition of a network initiated handover being performed at the same time.

In the mobile terminal of the present invention, the network initiated handover processing by the predetermined device preferably is detected with transmission by the mobile terminal of a report to the first access network, the report indicating examination of an access network environment surrounding the mobile terminal. This configuration enables recognition of a network initiated handover being performed.

In the mobile terminal of the present invention, the flag information preferably requests to notice, when path switching is completed by a network initiated handover processing performed by the predetermined device of the communication network as a control entity, as such. This configuration can tell the completion of path switching by the network initiated handover processing.

According to the present invention, a connection management device that performs connection management of a mobile terminal used in a handover processing method for the mobile terminal is provided. The mobile terminal performs communication with a correspondent node via a communication network including a plurality of access networks including first and second access networks in a communication system, a plurality of control entities that control a handover of the mobile terminal existing in the communication system, each control entity performing a handover processing of the mobile terminal. The connection management device includes: a reception means that receives a binding update message including flag information added by the mobile terminal; a determination means that determines whether an update processing of a binding cache based on the binding update message is completed or not; a message generation means that, when it is determined that the update processing of the binding cache is completed, generates a path switching completion notification message indicating path switched; and a transmission means that transmits the generated path switching completion notification message to the mobile terminal. This configuration avoids a handover failure due to a collision of a network initiated handover processing and a UE initiated handover processing, so that communication is enabled via a desired access network as a UE initiated handover target.

In the connection management device of the present invention, the flag information preferably requests to notice, when path switching is completed by a network initiated handover processing performed by the predetermined device of the communication network as a control entity, as such. This configuration can tell the completion of path switching by the network initiated handover processing.

According to the handover processing method, and the mobile terminal and the connection management device used in the method of the present invention, when detecting a network initiated handover performed at the same time, an indication is issued so as to update a data path again, whereby failures in both handovers are avoided, and communication is enabled via an access network as a UE initiated handover target that is originally optimal.

### BRIEF DESCRIPTION OF THE DRAWINGS

FIG. 1 is a configuration diagram illustrating an exemplary configuration of a mobile communication system in Embodiments 1 and 2 of the present invention.

FIG. 2 is a sequence chart to describe one exemplary solution in Embodiment 1 of the present invention.

FIG. 3 illustrates a message format illustrating one example of a message including a reconnection request flag in Embodiments 1 and 2 of the present invention.

FIG. 4 illustrates a message format illustrating one example of a message including a storage request flag in Embodiments 1 and 2 of the present invention.

FIG. 5 illustrates a message format illustrating one example of a message including a network initiated handover stop flag in Embodiment 1 of the present invention.

FIG. 6 is a configuration diagram illustrating an exemplary configuration of a BS in Embodiment 1 of the present invention.

FIG. 7 illustrates another message format illustrating one example of a message including a network initiated handover stop flag in Embodiment 1 of the present invention.

FIG. 8 is a configuration diagram illustrating an exemplary configuration of a base station (BS) in Embodiment 1 of the present invention.

FIG. 9 is a configuration diagram illustrating an exemplary configuration of a base station (BS) in Embodiment 1 of the present invention.

FIG. 10 is a sequence chart to describe one exemplary solution in Embodiment 2 of the present invention.

FIG. 11 is another sequence chart to describe one exemplary solution in Embodiment 2 of the present invention.

FIG. 12 is a configuration diagram illustrating an exemplary configuration of a mobile terminal (UE) according to Embodiments 1 and 2 of the present invention.

FIG. 13 is a sequence chart illustrating one example of a message sequence of a UE initiated handover in the conventional mobile communication system.

FIG. 14 is a sequence chart illustrating one example of a message sequence of a network initiated handover in the conventional mobile communication system.

FIG. 15 is a sequence chart illustrating one example of a message sequence when a UE initiated handover and a network initiated handover occur simultaneously in the conventional mobile communication system.

FIG. 16 is another sequence chart illustrating one example of a message sequence when a UE initiated handover and a network initiated handover occur simultaneously in the conventional mobile communication system.

FIG. 17 is still another sequence chart illustrating one example of a message sequence when a UE initiated handover and a network initiated handover occur simultaneously in the conventional mobile communication system.

FIG. 18A is a sequence chart illustrating one example of a message sequence of a network initiated handover in the conventional mobile communication system.

FIG. 18B is a sequence chart illustrating one example of a message sequence of a network initiated handover in the conventional mobile communication system.

FIG. 19 is a configuration diagram illustrating an exemplary configuration of a mobile communication system in Embodiments 1 and 2 of the present invention.

FIG. 20 is a sequence chart to describe one exemplary solution in Embodiment 3 of the present invention.

FIG. 21 illustrates a message format illustrating one example of a handover confirmation message in Embodiments 3 and 4 of the present invention.

FIG. 22 illustrates a message format illustrating one example of a path switching completion notification (to MME) in Embodiment 3 of the present invention.

FIG. 23 illustrates a message format illustrating one example of a path switching completion notification (from MME) in Embodiment 3 of the present invention.

FIG. 24 is a sequence chart to describe one exemplary solution in Embodiment 4 of the present invention.

FIG. 25 is a configuration diagram illustrating an exemplary configuration of a package gateway (PG) in Embodiments 3 and 4 of the present invention.

### DESCRIPTION OF EMBODIMENTS

### Embodiment 1

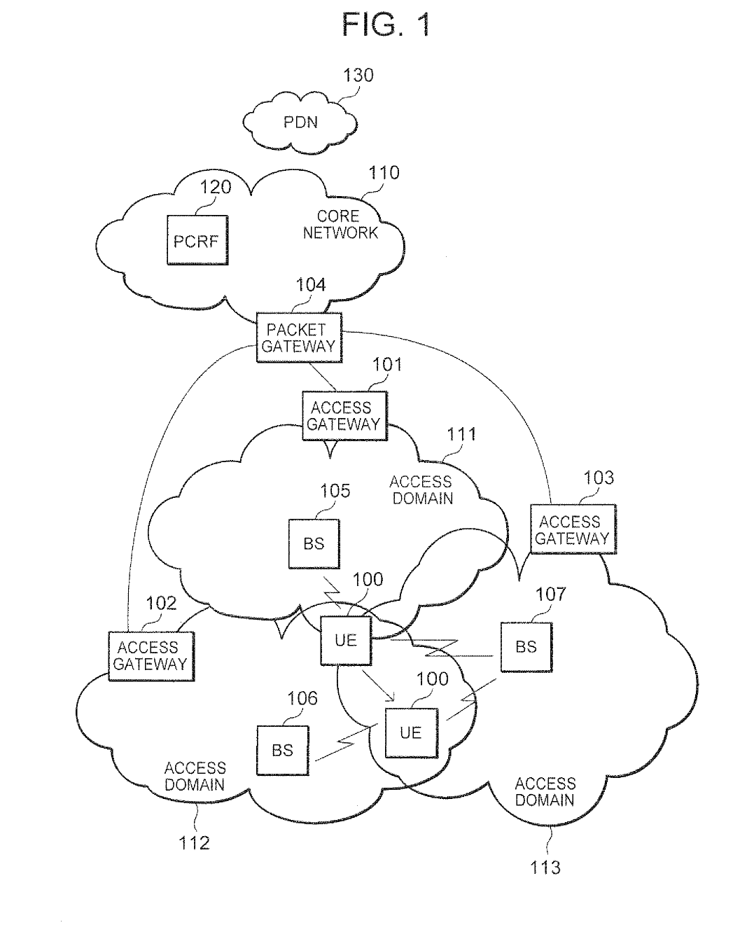

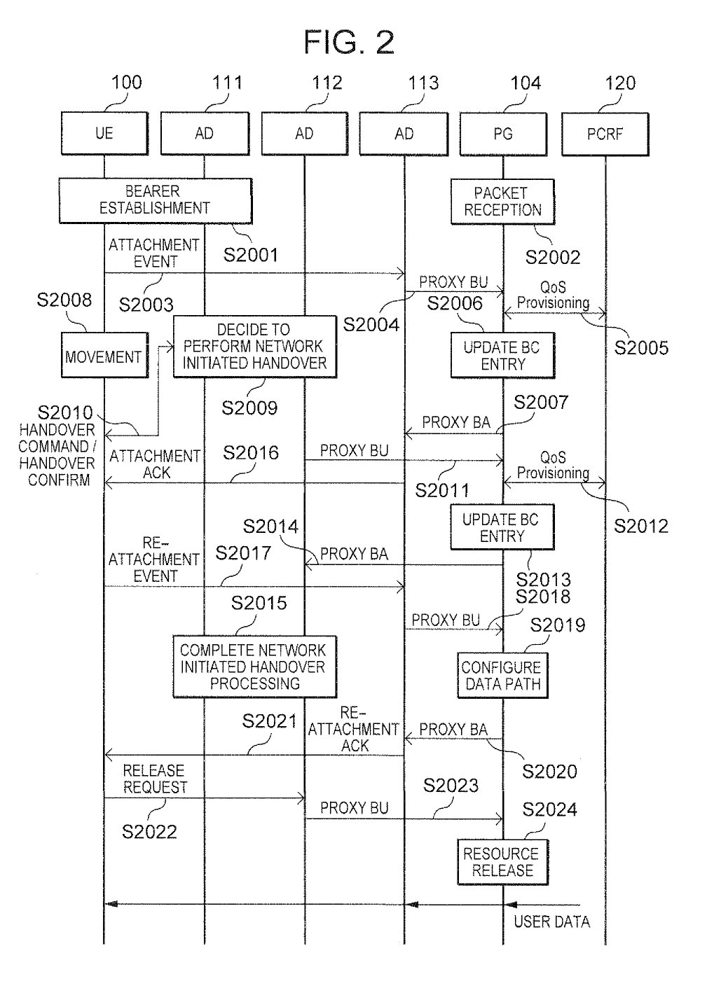

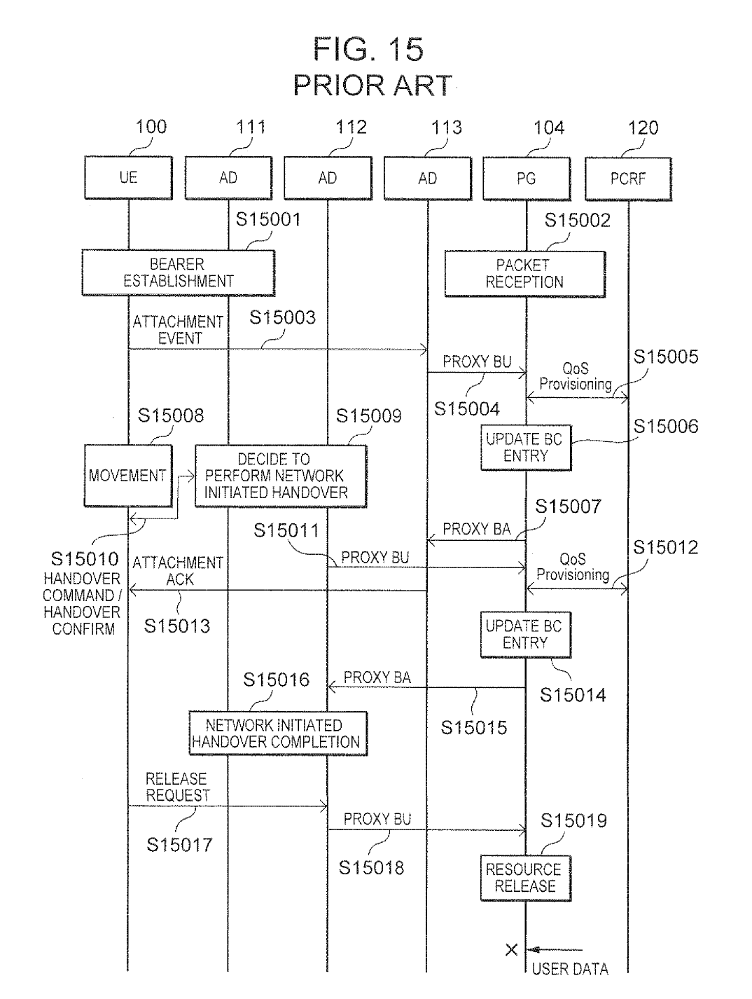

Embodiment 1 of the present invention is described below. Firstly, a handover processing method in Embodiment 1 is described with reference to FIGS. 1 and 2. FIG. 2 describes a method to cope with the problem (the first case) described above referring to FIG. 15. FIG. 1 illustrates a configuration similar to the conventional mobile communication system as one example.

Assume herein that a UE 100 establishes a bearer with a packet gateway PG 104 via an access domain AD 111 (Step S2001), and the UE 100 can correctly receive a packet addressed to the UE 100 from the PG 104 via an access gateway AG 101 and a base station BS 105 in the AD 111 (Step S2002). When the UE 100 decides to perform handover to a non-3GPP access domain AD 113, the UE 100 transmits an attachment event as a connection establishment request to a BS 107 (Step S2003). The AG 103, to which the connection establishment request is transferred from the BS 107, transmits a proxy BU (proxy binding update) to the PG 104 which the UE 100 is attaching to (Step S2004).

The PG 104 acquires QoS policy information from a PCRF 120 and configures them (QoS Provisioning: Step S2005), and updates a binding cache (BC) entry of the UE 100 for the AG 103 (Step S2006) and transmits a proxy BA (proxy binding ack) to the AG 103 (Step S2007). Substantially at the same time, it is decided to perform a network initiated handover (Step S2009) because the UE 100 moves to an area possible to connect to a base station BS 106 of the access domain AD 112, for example (Step S2008). Then, a handover initiation indication (i.e. handover command) is noticed from the BS 105 to the UE 100, and receiving this, the UE 100 transmits a handover confirmation message (handover confirm) to the BS 106 as a handover target (Step S2010).

The BS 106 transmits a path switching request to the AG 102, and the AG 102 transmits a proxy BU to the PG 104 (Step S2011). The PG 104 acquires QoS policy information and configures them (QoS Provisioning: Step S2012), updates a binding cache (BC) entry for the AG 102 (Step S2013), and returns a proxy BA to the AG 102 (Step S2014). Thereby, the network initiated handover processing for the UE 100 from the AD 111 to the AD 112 is completed (Step S2015).

Herein, the UE 100 detects the network initiated handover being executed in spite of the UE initiated handover being performed. More specifically, the UE 100 detects as follows.

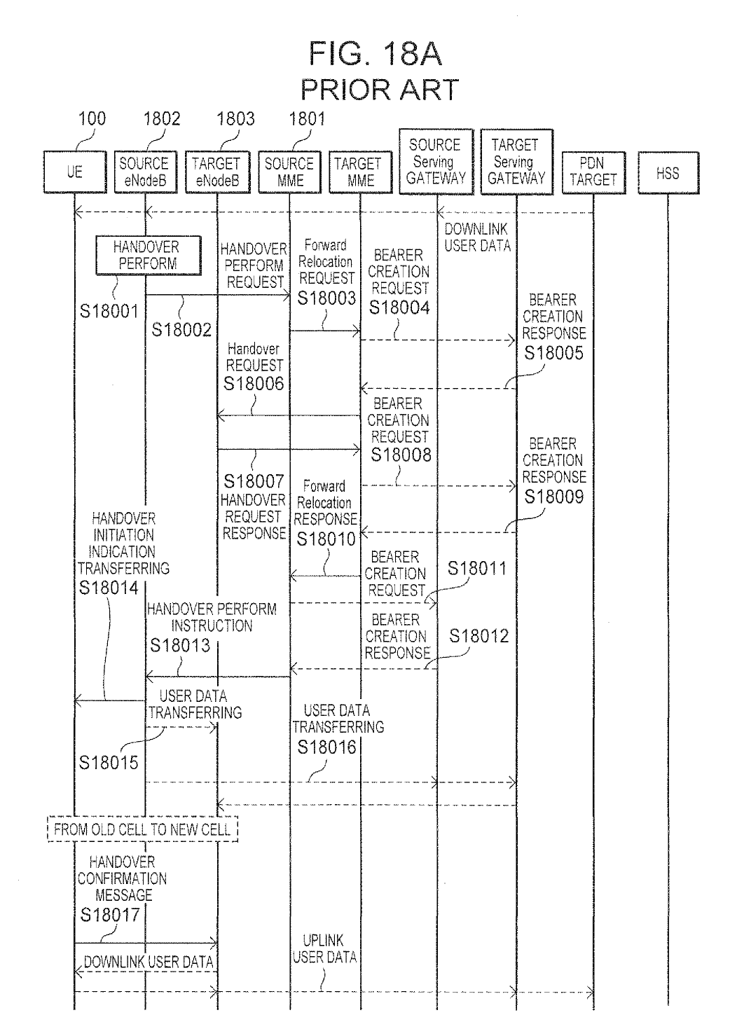

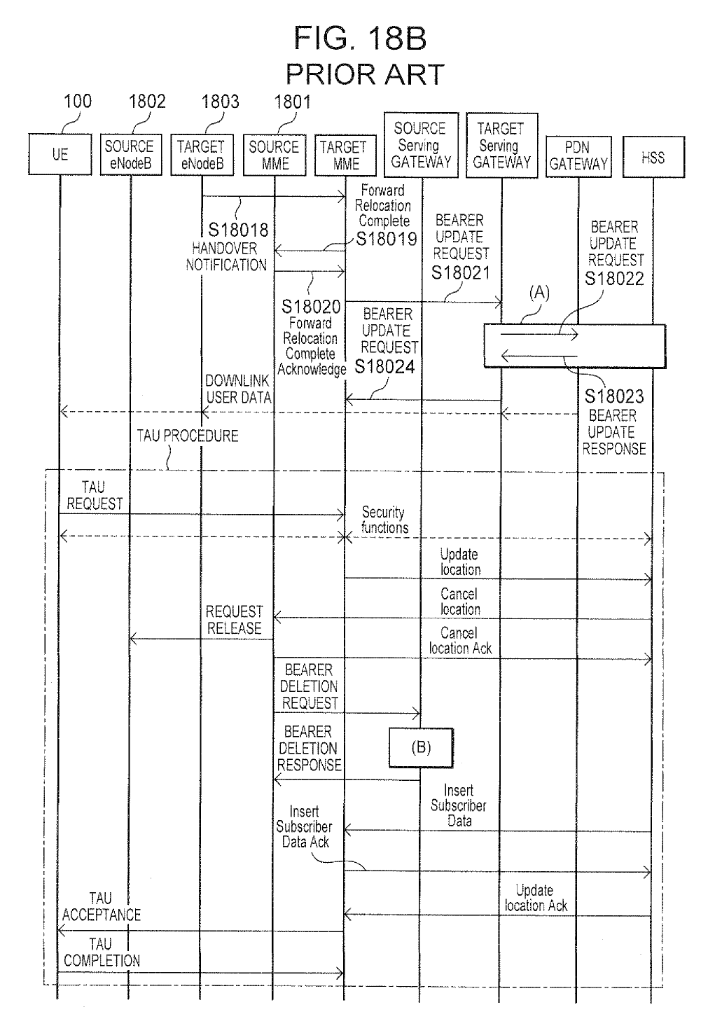

As one detection method, after issuing the connection establishment request to the BS 107 in the access network AD 113 as a UE initiated handover target, it would be detected if an inter-base station handover or an inter-RAT (Radio Access Technology) handover is performed in the access network (AD 111) as a handover source. More specifically, the network initiated handover is detected with occurrence of Step S2010 of FIG. 2 (in more detail, reception of handover initiation indication (handover command: Step S18014) and transmission of a handover confirmation message (Step S18017) of FIG. 18A, or transmission of a handover confirmation message only) (refer to Non-Patent Document 3).

As another detection method, after issuing (sending) the connection establishment request to the BS 107 in the access network AD 113 as a UE initiated handover target, a network initiated handover can be detected with transmission of a measurement report in the access network as the handover source, which is determined as induction of a network initiated handover. More specifically, when a measurement report indicating that a wireless environment in the AD 112 is overwhelmingly more preferable than in the AD 111 (e.g., a measurement result indicating that electric field intensity is preferable, a reception error rate is preferable, or the like) is transmitted, a possibility of a network initiated handover to the AD 112 is assumed to be performed in the AD 111. Further, the content of the measurement reports transmitted recently can be evaluated with respect to a history information indicating whether a network initiated handover being actually performed or not, whereby a condition of possible network initiated handover being initiated is estimated. Further, the condition of possible network initiated handover being initiated, which is downloaded from a network or is stored in a SIM card or a memory of the UE 100 beforehand, may be used for the estimation.

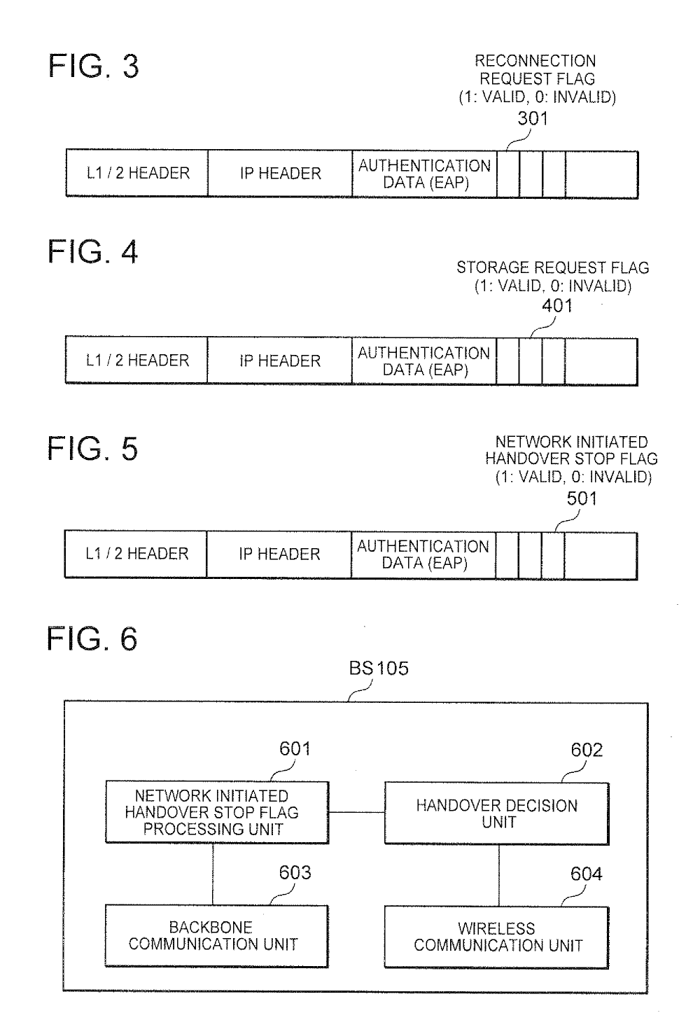

In this way, in response to the detection of both types of handovers being performed and reception of an attachment ack from the AG 103 (Step S2016) as a response to the connection establishment request, the UE 100 detects that the data path in the PG 104 is not configured correctly (i.e. different from the intention of the UP 100) and transmits a re-attachment event (Step S2017) as a reconnection request to the BS 107. The re-attachment event can be implemented as almost same configuration and contents as those of the message for the attachment event. The UE 100 can add a flag (reconnection request flag 301) to the re-attachment event, the flag indicating to reuse the contexts (e.g., an ID and key data calculated and generated due to this connection establishment request) which were prepared due to the connection establishment request accepted before other than the proxy BU processing. FIG. 3 illustrates one example of a message format of this re-attachment event. The insertion position of the flag in this drawing is just one example, which does not limit the insertion position thereto. Thereby, only reconfiguration of the data path in the PG 104 can be performed, so that handover time can be reduced.

Herein, the UE 100 can issue a similar indication when a first connection establishment request is transmitted to the BS 107. More specifically, the UE 100 may add a flag (storage request flag 401) to the attachment event (Step S2003), the flag indicating to temporarily store a context such as an ID and key data calculated or generated due to this connection establishment request because a reconnection establishment request may be transmitted later. FIG. 4 illustrates one example of a message format of this attachment event. The insertion position of the flag in this drawing is just one example, which does not limit the insertion position thereto. Thereby, a corresponding entity in the AD 113, e.g., an AAA (Authentication Authorization Accounting) server in the system, a proxy AAA server, or the access gateway AG 103 and the PG 104 can temporarily store data (context) generated due to the connection establishment request received from the UE 100, and can execute only the proxy BU processing immediately when a reconnection request (Step S2017) is generated later, so that handover time can be reduced.

Receiving the re-attachment event from the UP 100, the respective entities (AAA server, proxy AAA server, and access gateway AG 103) in the AD 113 and the PG 104 reuse the data (context) generated due to the preceding connection establishment processing to execute a connection establishment processing, and the AG 103 immediately transmits a proxy BU to the PG 104 (Step S2018). The PG 104 reuses the QoS policy information acquired from the PCRF 120 before (i.e. does not make any inquiry to the PCRF 120 again), updates the BC entry for the AG 103 and reconfigures the data path (Step S2019), and transmits a proxy BA to the AG 103 (Step S2020). In response to this, a re-attachment ack as a response to the reconnection request is returned via the BS 107 to the UE 100 (Step S2021).

Receiving the re-attachment ack from the BS 107, the UE 100 releases the resource allocated for the UE 100 in the AD 112 (Steps S2022 to S2024). Herein, when the release of the resource in the AD 112 is triggered (performed) by the PG 104, the resource in the AD 112 can be correctly released because the resource in the access domain, to which a data path is directed before the current configuration, is targeted.

It can be considered that, in conjunction with the processes based on the present invention, a network initiated handover is performed again so that a data path is overwritten directed to the access network (AD 112) as a network initiated handover target. As one example of a solution when the UE 100 detects such a situation (i.e. both types of handover are being performed), a flag (network initiated handover stop flag 501) urging to stop the network initiated handover can be set in the connection establishment request (re-attachment event) to be resent through the access network as the UE initiated handover target. FIG. 5 illustrates one example of a message format of this re-attachment event. The insertion position of the flag in this drawing is just one example, which does not limit the insertion position thereto.

A mobile terminal detects the recurrence of a network initiated handover by a method as described below.

One detection method is as follows. That is, a packet is continuously received via an access network as a UE initiated handover source (actually access network as a network initiated handover target), whereby recurrence of a network initiated handover can be detected. Another detection method is as follows. That is, a predetermined of number of times or more of connection failure responses are received from an access network as a UE initiated handover target, whereby recurrence of a network initiated handover can be detected. This predetermined number of times is twice, for example.

The content of the network initiated handover stop flag 501 is transferred from the PG 104 to the BS 105 via the AG 101, which is used to determine if handover needs to be initiated by the BS 105. Thereby, the network initiated handover that would occur later can be stopped, and a data path can be settled so as to be directed to the access network as a UE initiated handover target.

Referring now to FIG. 6, an exemplary specific processing by the BS 105 is described. As illustrated in FIG. 6, a network initiated handover stop flag processing unit 601 processes the content of the network initiated handover stop flag received from the PG 104 via the AG 101 through a backbone communication unit 603, and notices it to a handover decision unit 602.

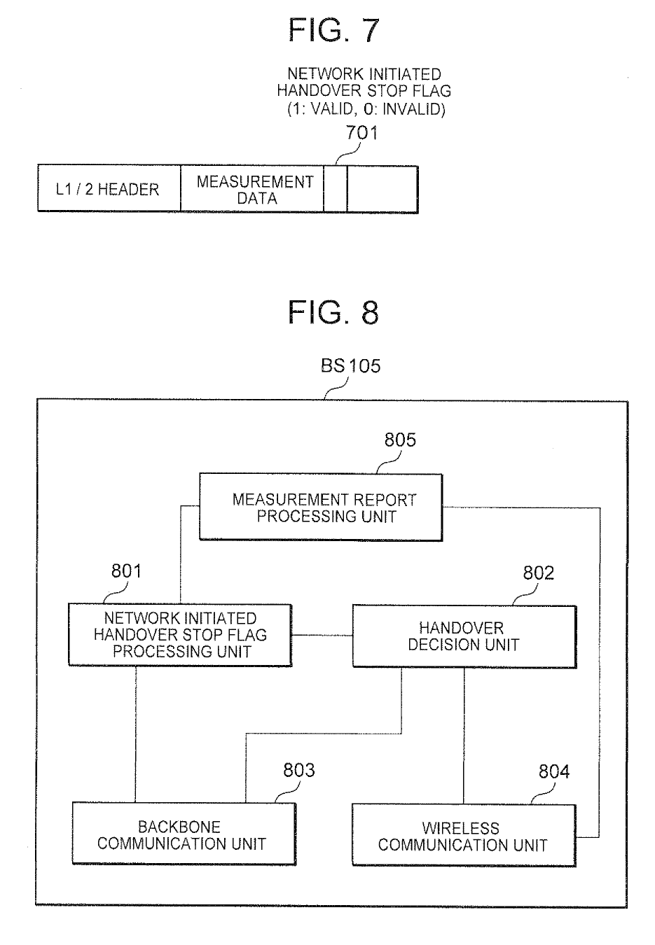

Herein, the content of the network initiated handover stop flag may be noticed from the AG 101 directly to the BS 105, may be noticed as a part of area information, or may be noticed via a MME (Mobility Management Entity). Further, the UE 100 may add the network initiated handover stop flag to a measurement report or a control plane message. Receiving a valid measurement report or such a control plane message with a network initiated handover stop flag 701 added thereto, the BS 105 is controlled so as not to perform a subsequent network initiated handover. FIG. 7 illustrates one example of a message format when a network initiated handover stop flag is added to a measurement report. The insertion position of the flag in this drawing is just one example, which does not limit the insertion position thereto.

Referring now to FIG. 8, an exemplary specific processing by the BS 105 is described. As illustrated in FIG. 8, a measurement report processing unit 805 acquires a network initiated handover stop flag from a measurement report received via a wireless communication unit 804, and a network initiated handover stop flag processing unit 801 processes and notices it to a handover decision unit 802.

The network initiated handover stop flag may be noticed from the PG 104 to the BS 106 via the AG 102. Thereby, the network initiated handover stop flag can be used for handover authorization the BS 106 performs. That is, when receiving a handover request from the BS 105, the BS 106, receiving a notification indicating that the network initiated handover stop flag is valid beforehand, does not accept the handover, and further transmits a handover request response to the BS 105, to which a request to stop the subsequent handover is added.

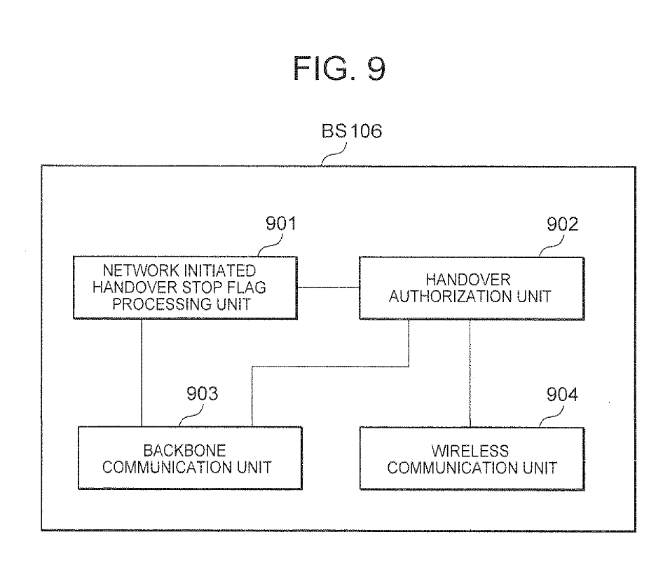

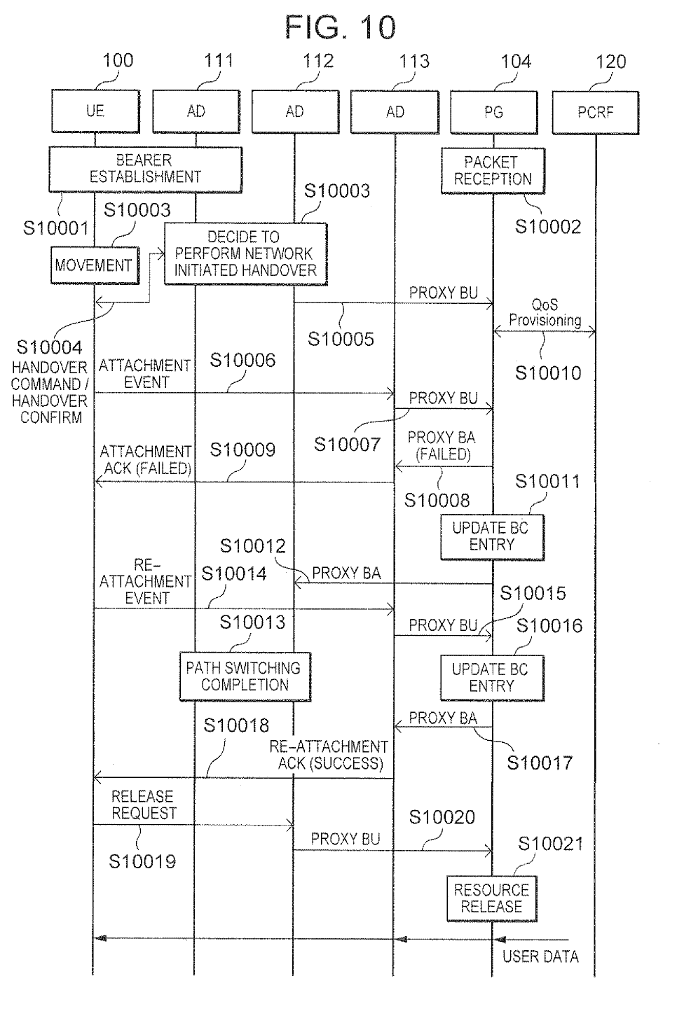

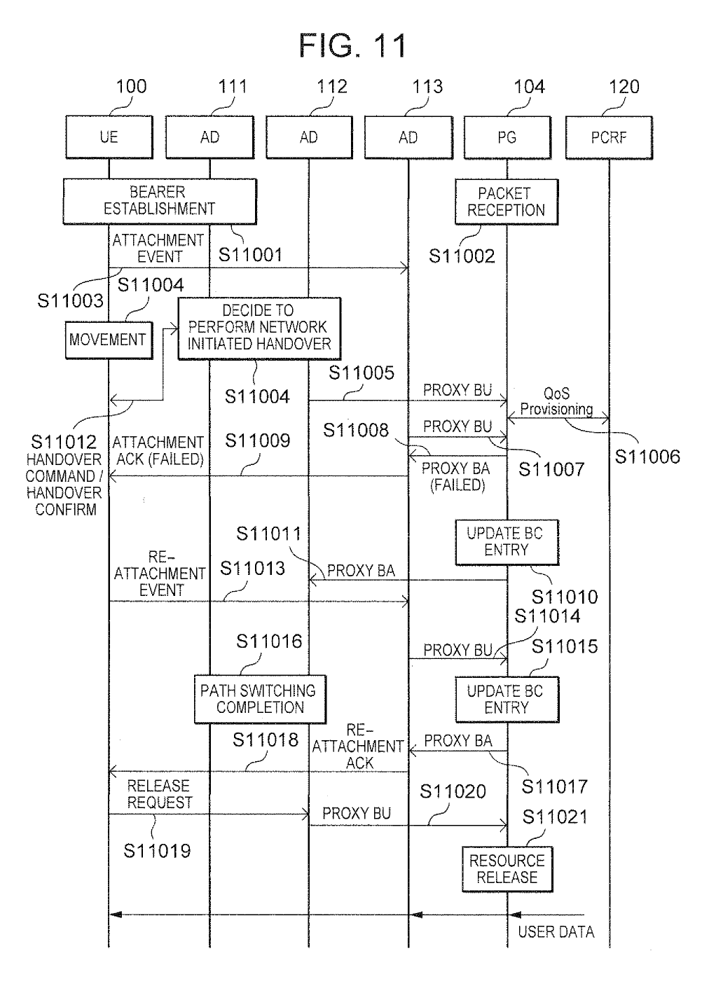

Referring now to FIG. 9, an exemplary specific processing by the BS 106 is described. As illustrated in FIG. 9, a network initiated handover stop flag processing unit 903 processes the content of the network initiated handover stop flag received from the PG 104 via the AG 102 through a backbone communication unit 903, and notices it to a handover authorization unit 902. Receiving a handover request from the BS 105, the handover authorization unit 902 does not accept a handover, and transmits a handover request response to the BS 105, to which a request to stop the subsequent handover is added.

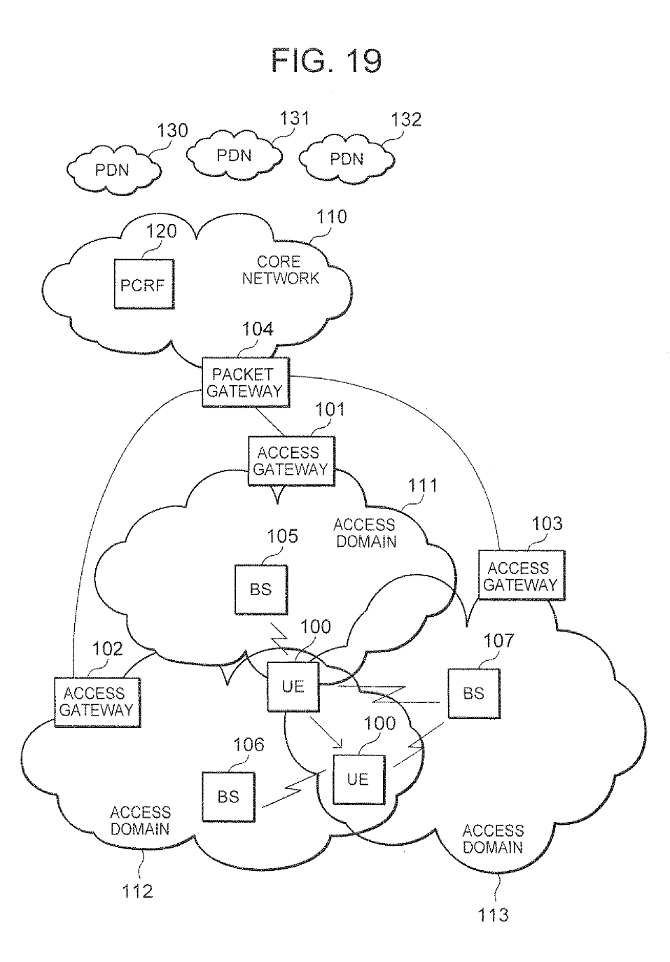

Herein, as illustrated in FIG. 19, when the UE 100 has connections to a plurality of PDNs 130 to 132 at the same time, only a part of connections to specific PDNs may be target for the handover. For instance, only the connections with the PDNs 130, 131 are target for the handover, and another connection to the PDN 132 is not subjected to the handover and remains in the current access network. Similarly, only a part of connections to specific PDNs may be target for the network initiated handover. Referring to FIG. 2, an operation of the handover processing method of the present invention in this case is described. Note here that the basic operation is the same as in the above description, and the following description is only for a different operation.

In the attachment event S2003, the UE 100 indicates to perform handover for all connections to PDNs 130 to 132 to the AD 113. More specifically, APNs (Access Point Name) designating the PDNs 130 to 132, one corresponding to a designated PDN among an address or a prefix distributed from the PDN, or alternative PDN connection identifiers are described in the attachment event for transmission. Thereby, the PG 104 conducts path configuration so that connections with all PDNs 130 to 132 are via the AD 113 (S2006).

The network initiated handover generated at the same time, however, configures the path for the connections to the PDNs 130, 131 established via the AD 112 (S2013). Receiving a notification of occurrence of a network initiated handover as well as a notification of the PDNs 130, 131 as the handover target with a handover command, the UE 100 transmits a re-attachment event, in which APNs (or corresponding address/prefix or alternative PDN connection identifier, hereinafter collectively called a PDN connection identifier) corresponding to these PDNs are included (S2017). When the PDNs targeted as the network initiated handover are not indicated in the handover command, a re-attachment event is transmitted, in which PDN connection identifiers such as APNs corresponding to all the PDNs 130 to 132 are described or any PDN connection identifiers such as APNs are not described (S2017). In response to this, path configuration is performed again so that the connections to the PDNs 130, 131 targeted as the network initiated handover and to all PDNs 130 to 132 including them are established via the AD 113, so that a desired UE initiated handover can be normally completed.

### Embodiment 2

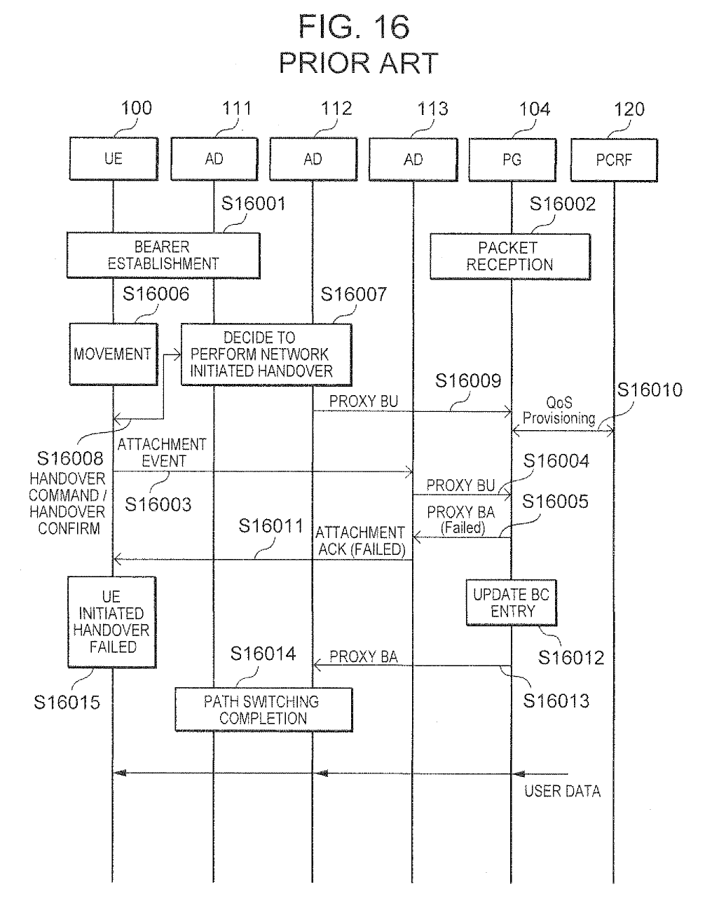

Embodiment 2 of the present invention is described below. Firstly, a handover processing method in Embodiment 2 is described with reference to FIGS. 1 and 10. FIG. 10 describes a method to cope with the problem (the second case) described above referring to FIG. 16.

Assume herein that a UE 100 establishes a bearer with a packet gateway PG 104 via an access domain AD 111 (Step S10001), and the UE 100 can correctly receive a packet addressed to the UE 100 from the PG 104 via the AD 111 (Step S10002). When a network initiated handover is decided to be performed (Step S10003) because the UE 100 moves to an area possible to connect to an AD 112, the UE 100 receives a handover command from the BS 105 and transmits a handover confirmation message (handover confirm) to the BS 106 (Step S10004). In response to this, the AG 102 transmits a proxy BU to the PG 104 (Step S10005).

At the same time, when the PG 104 receives QoS policy information for the AD 112 from the PCRF 120, the UE 100 decides to perform handover to the AD 113 based on a wireless environment measurement result of the BS 107 in the AD 113 and a handover policy. Then the UE 100 transmits an attachment event as a connection establishment request to an AG 103 via the BS 107 (Step S10006), and the AG 103 transmits a proxy BU to the PG 104 (Step S10007). At this time, however, since the PG 104 is on the process of the already received handover request for the UE 100 (handover for the AD 112), the PG 104 cannot accept a new handover request (handover for the AD 113).

Thus, the PG 104 returns a NACK (Failed) to the AG 103 with a proxy BA (Step S10008). Thereby, the connection establishment request to the AD 113 is not accepted, and a response of the connection failure (attachment ack (failed) is returned to the UE 100 (Step S10009). On the other hand, the handover to the AD 112 is correctly executed (Steps S10010, 10011, 10012), and path switching from the AG 101 to the AG 102 is completed (Step S10013).

Herein the UE 100 detects both the UE initiated handover and the network initiated handover being performed at the same time. More specifically, on the conditions that after the handover command is received from the BS 105 in the AD 111 due to the network initiated handover and the handover confirmation message is transmitted to the BS 106 in the AD 112 (Step S10004), the connection establishment request (attachment event) is transmitted to the BS 107 in the AD 113 due to the UE initiated handover (Step S10006), the UE 100 detects both of the handovers being performed at the same time.

Receiving the result of a connection failure via the AD 113 (Step S10009), the UE 100 detects that the data path in the PG 104 is not configured correctly (i.e. different from the intention of the UE 100) and transmits a re-attachment event as a reconnection request to the BS 107 in the AD 113 (Step S10014). At this time, the UE 100 adds a flag (reconnection request flag) indicating to reuse the result of the connection establishment request performed before for the processes other than the proxy BU processing. FIG. 3 illustrates one example of a message format. The insertion position of the flag in this drawing is just one example, which does not limit the insertion position thereto. Thereby, reconfiguration of the data path for the PG 104 only can be performed, so that handover time can be reduced.

Herein, the UE 100 can issue a similar indication when a first (initial) connection establishment request is transmitted to the AD 113. More specifically; the UE 100 adds a flag (storage request flag) to the attachment event (Step S10006), the flag indicating to temporarily store a context such as an ID and key data to be calculated or generated due to this connection establishment request because a reconnection request may be transmitted later. FIG. 4 illustrates one example of a message format. The insertion position of the flag in this drawing is just one example, which does not limit the insertion position thereto. Thereby, a corresponding entity in the AD 113, e.g., an AAA server in the system, a proxy AAA server, or the access gateway AG 103 and the PG 104 can temporarily store data (context) generated due to the connection establishment request from the UE 100, so that the AD 113 can only execute a proxy BU processing immediately when receiving a reconnection request (Step S10014) later. Such that handover time can be reduced.

It has been already clarified at that time that both types of handovers are executed in an overlapping manner, and it is possible to instruct the storing of the data (context) with a higher probability than in the above-stated first handover processing method, so that resource efficiency can be improved in the AD 113 and the core network.

Receiving the re-attachment event as a reconnection request from the UE 100, the respective entities (AAA server, proxy AAA server, access gateway AG 103 or the like) and the PG 104 reuse the data (context) generated due to the preceding connection establishment processing to perform a connection establishment processing, and the AG 103 immediately transmits a proxy BU to the PG 104 (Step S10015). The PG 104 reuses the QoS policy information acquired from the PCRF 120 before (i.e. does not make an inquiry to the PCRF 120 again), configures a data path to the AG 103 (Step S10016) and transmits a proxy BA to the AG 103 (Step S10017). In response to this, a re-attachment ack (success) as a response to the reconnection request is returned to the UE 100 (Step S10018).

Receiving the re-attachment ack from the BS 107, the UE 100 releases the resource allocated for the UE 100 in the AD 112 (Steps S10019 to 10021). Herein, when the release of the resource in the AD 112 is triggered (performed) by the PG 104, the resource in the AD 112 can be correctly released because the resource in the access domain, to which a data path is directed before the current configuration, is targeted.

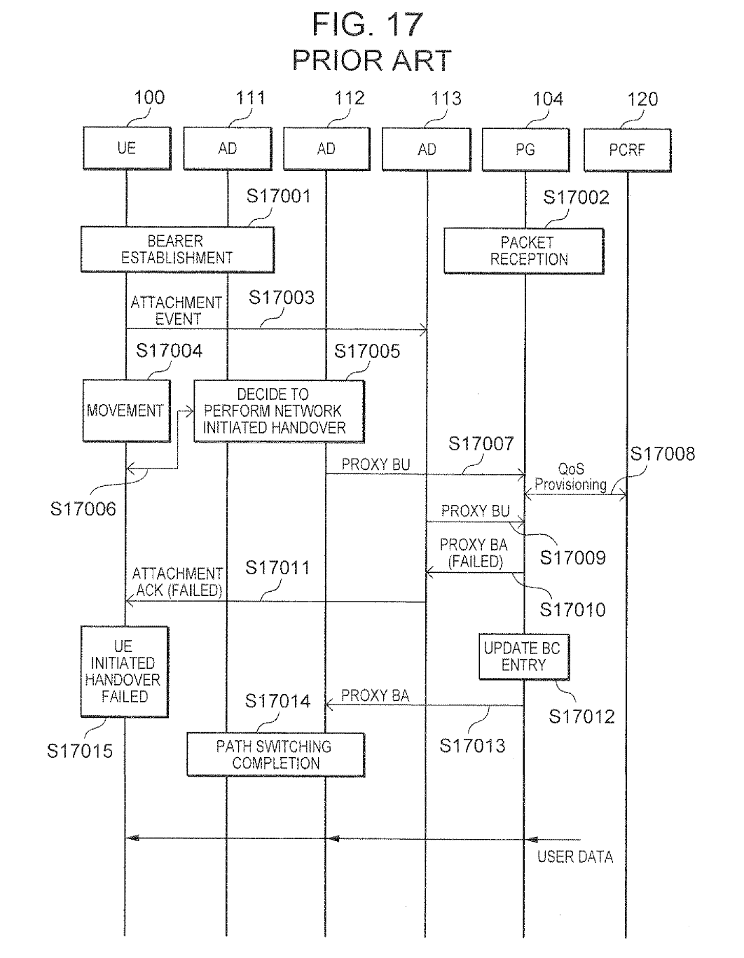

Herein, the attachment event (Step S10006) may be transmitted prior to the initiation of the network initiated handover (Step S10003). FIG. 11 illustrates one example of a solution for the problem (described referring to FIG. 17) occurring in such a situation, which is the same as FIG. 10 in basic operation, therefore the description therefor is omitted.

When the UE 100 tries to perform handover (i.e. UE initiated handover) in the state where a network initiated handover has been already performed, the UE 100 sets a flag to a reconnection request (re-attachment event) to be transmitted to an access network as a UE initiated handover target, the flag indicating involving equipments in the access network to store data (context) generated due to the connection establishment processing even if the UE initiated handover is failed. This flag may be the same as the storage request flag 401 illustrated in FIG. 4, or may be different. In the former case, resource can be reduced because the message field, which is already provided, can be utilized as well for this purpose. In the latter case, it enables to implicitly indicate that data (context) generated at the time of the reconnection request processing is preferentially used, so that a determination processing in targeted equipment can be reduced.

The data (context) to be stored is one obtained by calculation or generation in response to a connection establishment request, including ciphers and/or an authentication key used for a communication after establishing the connection, a temporarily ID used by the UE 100 for communication and reconnection, an intermediate value for these parameters, and information (especially one dynamically acquired from other entities) required to generate the data (context), for example. Thereby, processes following re-attachment event can be limited to proxy BU/BA processing and a minimum processing related thereto, so that handover time can be reduced.

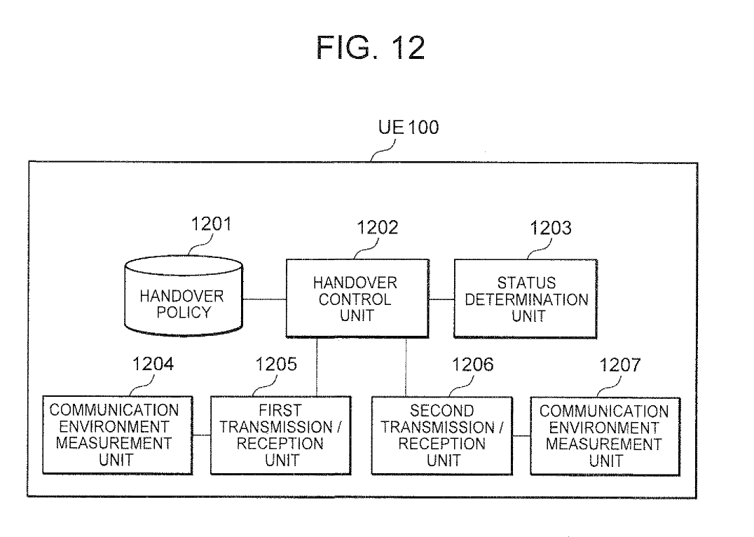

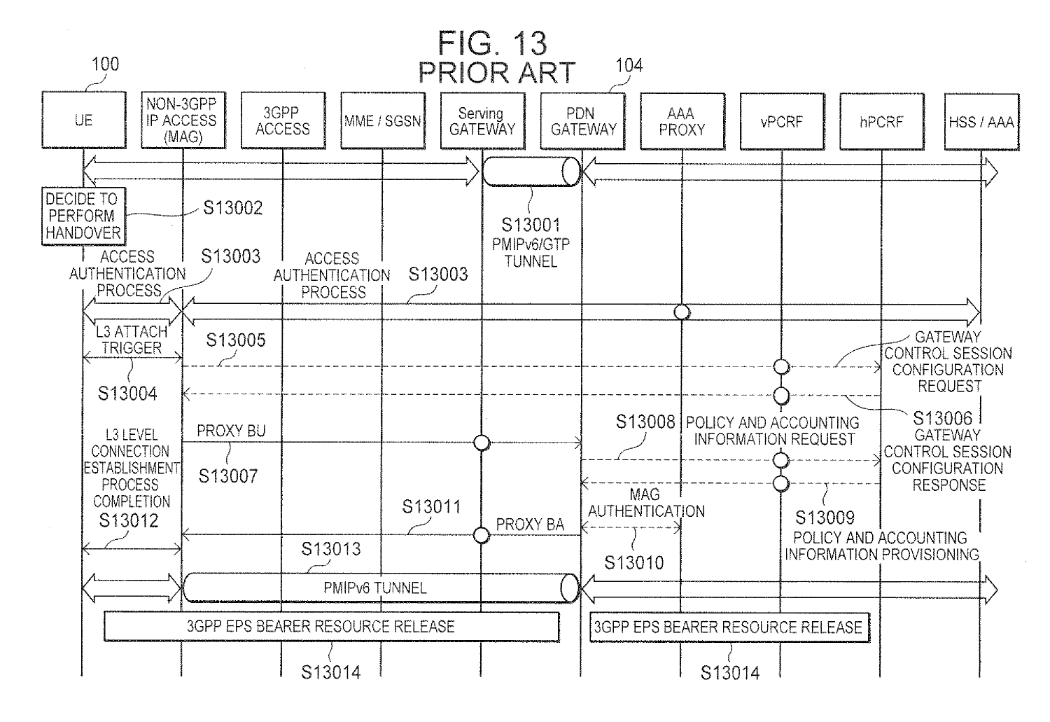

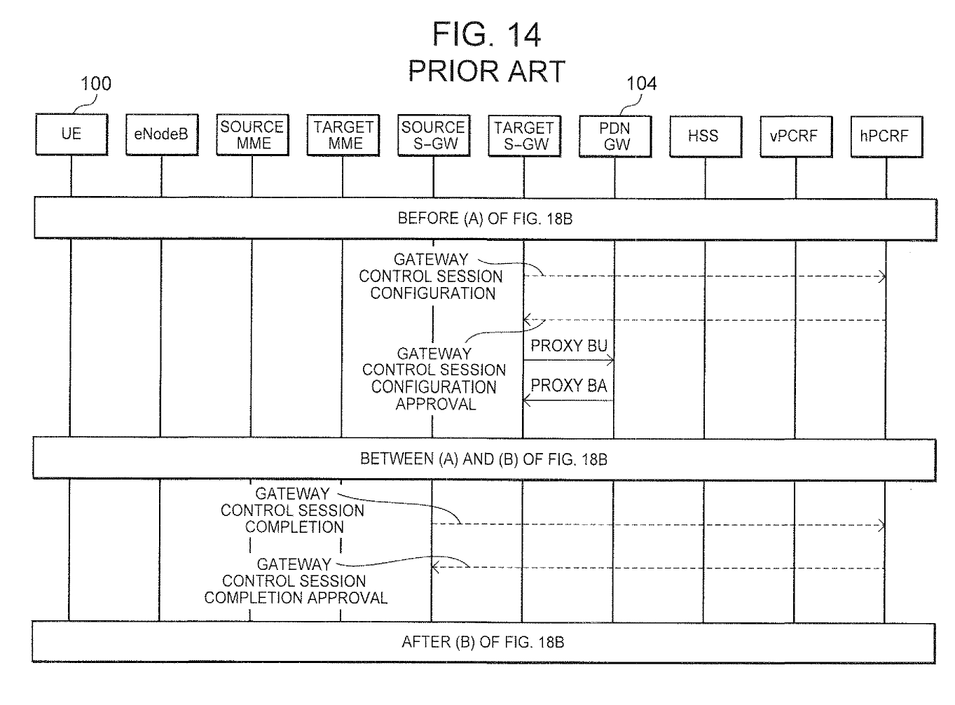

Referring now to FIG. 12, a mobile terminal (UE) according to Embodiments 1 and 2 of the present invention is described below. Major elements according to the present invention are a status determination unit and a handover control unit. The following mainly describes them.

Firstly, a status determination unit 1203 is described. The status determination unit 1203 generates a trigger to transmit a reconnection request (re-attachment event) message according to the present invention based on the status of handover initiation and a status of a mobile terminal. More specifically, the status determination unit 1203 detects the initiation of a network initiated handover based on exchanging of handover command/handover confirmation messages, and determines whether a reconnection request message is to be transmitted based on a result of a connection establishment request to a handover target access in a UE initiated handover.

In the handover processing method of Embodiment 1, the status determination unit 1203 specifically detects as follows. One detection method is as follows. After issuing a connection establishment request to the BS 107 in the access network AD 113 as a UE initiated handover target, the status determination unit 1203 would be detected if an inter-base station handover or an inter-RAT (Radio Access Technology) handover is performed in the access network (AD 111) as the handover source. More specifically, the network initiated handover is detected with occurrence of Step S2010 of FIG. 2 (in more detail, reception of handover initiation indication (handover command: Step S18014) and transmission of a handover confirmation message (Step S18017) of FIG. 18A, or transmission of a handover confirmation message only).

As another detection method, the following is available. After issuing (sending) a connection establishment request to the BS 107 in the access network AD 113 as a UE initiated handover target, the status determination unit 1203 can be detected with transmission of a measurement report in the access network as the handover source, which is determined as induction of a network initiated handover. More specifically, when a measurement report indicating that a wireless environment in the AD 112 is overwhelmingly more preferable than in the AD 111 (e.g., a measurement result indicating that electric field intensity is preferable, a reception error rate is preferable, or the like) is transmitted, a possibility of a network initiated handover to the AD 112 assumed to be performed in the AD 111. Further, the content of the measurement reports transmitted recently can be evaluated with respect to a history information indicating whether a network initiated handover being actually performed or not, whereby a condition of possible network initiated handover being initiated is estimated. Further, the condition of possible network initiated handover may be downloaded and used for the estimation.

In the handover processing method of Embodiment 2, the status determination unit 1203 receives a handover command from the BS 105 in the AD 111 in accordance with the network initiated handover and transmits a handover confirmation message to the BS 106 in the AD 112 (Step S10004), and thereafter transmits a connection establishment request to the BS 107 in the AD 113 in accordance with the UE initiated handover (Step S10006), thereby detecting both of the handovers being performed at the same time. Further, receiving a result of a connection failure from the AD 113 (Step S10009), the UE 100 detects that the data path in the PG 104 is not configured correctly (i.e. different from the intention of the UE 100).

In Embodiments 1 and 2, the status determination unit 1203 further detects recurrence of a network initiated handover. That is, in conjunction with the processing according to the present invention, the status determination unit 1203 detects by the following method that a network initiated handover performed again makes a data path overwritten into the content directed to the access network (AD 112) as the network initiated handover target, and notices it to a handover control unit 1202.

One detection method is as follows. That is, a packet is continuously received via an access network as the UE initiated handover source (actually access network AD 112 as a network initiated handover target), whereby recurrence of a network initiated handover can be detected. Another detection method is as follows. That is, a predetermined of number of times or more of connection failure response messages are received from an access network as a UE initiated handover target, whereby recurrence of a network initiated handover can be detected. This predetermined number of times is twice, for example.

The following describes the handover control unit 1202. The handover control unit 1202 performs reconnection request processing according to the present invention based on information output from the status determination unit 1203. More specifically, the status determination unit 1203 detects that the data path in the PG 104 is not configured correctly (i.e. different from the intention of the UE 100), and receiving the notification of such, the handover control unit 1202 transmits a re-attachment event as a reconnection request to the BS 107 in the AD 113 (Step S2017). At this time, a flag (reconnection request flag: Refer to FIG. 3) indicating to reuse the result of the connection establishment request performed before for processes other than the proxy BU processing is added to the reconnection request. Thereby, reconfiguration of the data path for the PG 104 only can be performed, so that handover time can be reduced.

Herein, the UE 100 can issue an indication to save reusable data (context) when a first connection establishment request is transmitted to the BS 107. More specifically, a flag (storage request flag: Refer to FIG. 4) is added to the attachment event (Step S2003), the flag indicating to temporarily store a context such as an ID and key data to be calculated or generated due to this connection establishment request because a reconnection request may be transmitted later. Thereby, a corresponding entity in the AD 113, e.g., an AAA server, a proxy AAA server, the base station BS 107, or the AG 103 and the like can temporarily store data (context) generated due to the connection establishment request from the UE 100, and can execute a proxy BU processing only immediately when a reconnection request (Step S2017) is generated later, so that handover time can be reduced.

Further, when the status determination unit 1203 detects recurrence of a network initiated handover, the handover control unit 1202 sets a flag (network initiated handover stop flag: Refer to FIG. 5) urging to stop the network initiated handover to the reconnection request.

A first transmission/reception unit 1205 and a second transmission/reception unit 1206 receive a packet or a message from an external access network and transmit a packet or a message to an external access network, which are for communication with a 3GPP access and for communication with a non-3GPP access, respectively. The first transmission/reception unit 1205 and the second transmission/reception unit 1206 may be one transmission/reception unit. Communication environment measurement units 1204 and 1207 measure a status of wireless communication (e.g., intensity of radio waves received) surrounding the UE 100, which create a report (measurement report) to report the measured wireless communication status if required and transmit it to a network via the transmission/reception units 1205 and 1206 connected therewith. A handover policy 1201 stores information used when the UE 100 performs a handover.

In the present invention, a handover with one base station placed in each access network (access domain) is described in detail. However, a handover with a plurality of base stations and SGWs placed in one access network can be considered similarly. In this case, a network initiated handover is a handover between base stations in a 3GPP access network (AD 111), and a UE initiated handover is a handover between a 3GPP access network (AD 111) and a non-3GPP access network (AD 113).

The above embodiments of the present invention describe the case where Proxy MIP is used for mobility management of a mobile terminal. However, especially when a mobile terminal is equipped with a mobile IP function such as DSMIP (Dual Stack Mobile IP) for the movement between a 3GPP access network and a non-3GPP access network, the mobile terminal transmits a binding update message to a packet gateway, so that position registration can be performed. At this time, the packet gateway receives the binding update message from the mobile terminal, and in order to establish a data path addressed to a care-of address included in the message, the packet gateway updates a binding cache entry of the corresponding mobile terminal, and notices a result thereof (data path establishment success or failure) to the mobile terminal with a binding acknowledge message.

The binding update message is transmitted after exchange of the attachment event and the attachment ack (attach success). When the packet gateway can update a binding cache entry correctly, a binding acknowledge message is returned indicating a data path establishment success. Herein, when the mobile terminal detects occurrence of a network initiated handover, for example, the mobile terminal may transmit a re-attachment event similarly to the above. However, since it already succeeds in the attachment, retransmitting of the binding update message is enough. Thereby, the binding cache entry that might be overwritten with a network initiated handover can be updated again so that a data path becomes directed to an access network as a handover target (i.e., a non-3GPP access network) by a UE initiated handover.

### Embodiment 3

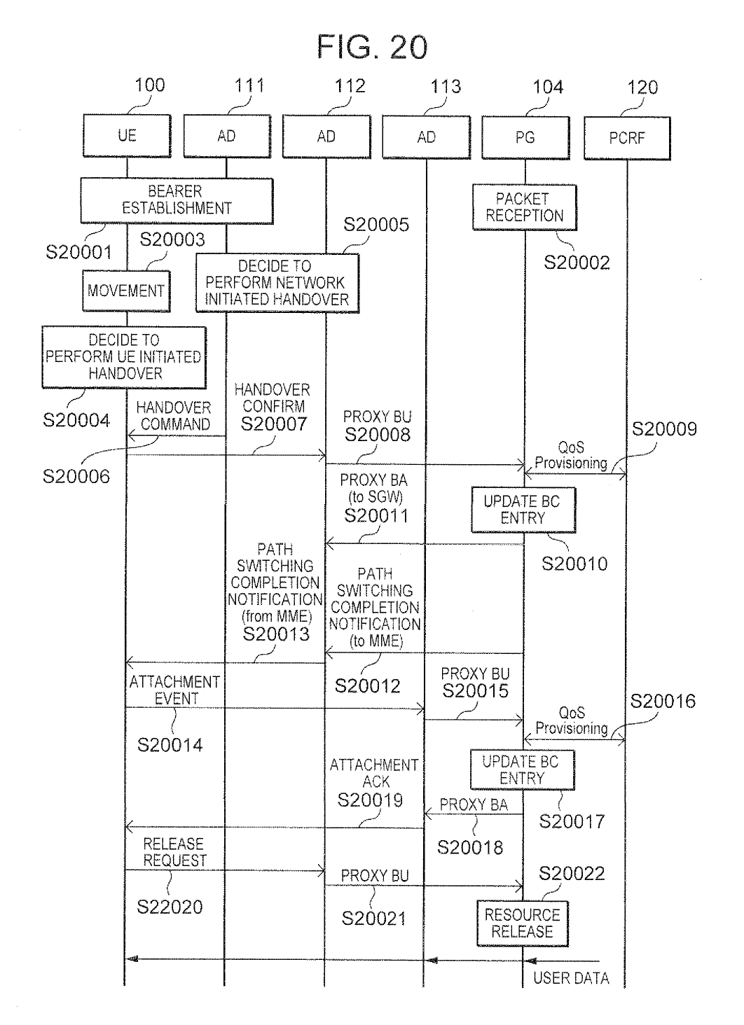

Embodiment 3 of the present invention is described below. Firstly, a handover processing method in Embodiment 3 is described with reference to FIGS. 1 and 20. According to the handover processing method in the present embodiment, when detecting a UE initiated handover and a network initiated handover being performed with conflict, a mobile terminal performs the UE initiated handover after obtaining a notification of the completion of path switching due to the network initiated handover, thus avoiding conflict of both types of the handover processes.

Assume herein that a UE 100 already established a bearer with a packet gateway PG 104 via an access domain AD 111 (Step S20001), and the UE 100 can correctly receive a packet addressed to the UE 100 from the PG 104 via the AD 111 (Step S20002). The UE 100 moves to an area possible to connect to an AD 112 (Step S20003), and the UE 100 decides to perform handover to the AD 113 based on a wireless environment measurement result of the BS 107 in the AD 113 and a handover policy (Step S20004). About that time, performing of a network initiated handover is decided (Step S20005), and then the UE 100 receives a handover command from the BS 105 (Step S20006).

In response to this, the UE 100 detects both of the UE initiated handover and the network initiated handover being performed at the same time. More specifically, on the conditions that a handover to the AD 113 is decided based on a wireless environment measurement result of the BS 107 in the AD 113 and a handover policy and a handover command is received from the BS 105 in the AD 111 due to the network initiated handover, the UE 100 detects both of the handovers being performed at the same time.

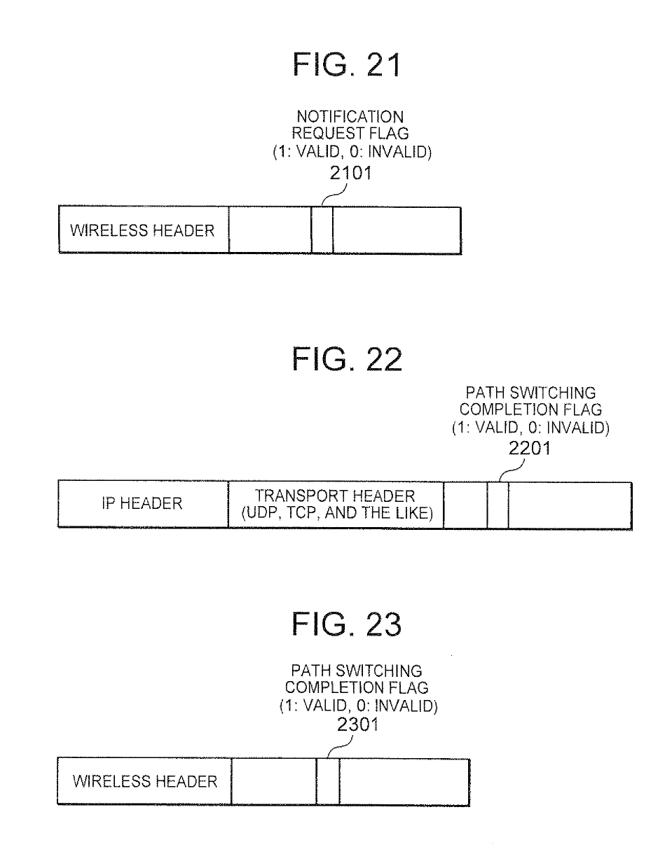

In response to this, the UE 100 transmits, to the BS 106, a handover confirmation message (handover confirm) with a notification request flag 2101 illustrated in FIG. 21 added thereto (Step S20007). In response to this, the AG 102 transmits a proxy BU to which the content of the notification request flag is transcribed to the PG 104 (Step S20008). This proxy BU may have a notification request flag similar to the handover confirmation message or may be of a different format so as to transfer the content of the notification request flag.

Receiving the proxy BU, the PG 104 acquires QoS policy information for the AD 112 from the PCRF 120 (Step S20009), configures the data path to the AG 102 (Step S20010), and transmits a proxy BA to the AG 102 (Step S20011). At the same time, the PG 104 transmits a path switching completion notification message to a mobility management entity MME in the AD 112 (Step S20012), and the MME transfers this to the UE 100 (Step S20013).

The path switching completion notification message transmitted from the PG 104 to the MME may have a format of an IP packet including a path switching completion notification flag 2201 as illustrated in FIG. 22, for example. The path switching completion notification message transmitted from the MME to the UE 100 may be a format of a wireless packet including a path switching completion notification flag 2301 as illustrated in FIG. 23, or one obtained by adding a wireless header to the IP packet of FIG. 22, for example. In response to this, the UE 100 detects that the path switching by the network initiated handover is completed, and immediately performs the UE initiated handover. That is, the UE 100 transmits an attachment event as a connection establishment request to the BS 107 (Step S20014), which is then transferred to the AG 103, and the AG 103 transmits a proxy BU to the PG 104 (Step S20015).

Thereby, conflict of the different types of handover processes, i.e. a UE initiated handover and a network initiated handover being performed at the same time, can be avoided, so that a reallocation of a system resource and wasting thereof due to a handover failure or repeating of any handover can be prevented. Further, the UE 100 detects the completion of data path switching, whereby a UE initiated handover can be actually performed quickly without waiting for the completion of the entire processing of the network initiated handover, thus leading to speeding up and higher efficiency of a handover processing.

The PG 104 acquires QoS policy information from the PCRF 120 (QoS Provisioning: Step S20016), updates a binding cache (BC) entry of the UE 100 so that a data path is directed to the AG 103 (Step S20017) and transmits a proxy BA (proxy binding ack) to the AG 103 (Step S20018). In response to this, an attachment ack is returned to the UE 100 (Step S20019).

Receiving the re-attachment ack via the BS 107, the UE 100 releases a resource allocated at the AD 112 (Step S20020). Herein, the releasing in the AD 112 resource may be triggered (performed) by the PG 104.

Herein, before receiving a handover command, the UE 100 can detect that performing of a network initiated handover is decided at the same time when the UE 100 intends to perform a UE initiated handover. More specifically, the UE 100 detects as follows.

About the time when a handover to the AD 113 is decided based on a wireless environment measurement result of the BS 107 in the AD 113 and a handover policy, the UE can detect with the transmission of a measurement report determined as induction of a network initiated handover in the access network AD 111 as a UE initiated handover source. More specifically, when a measurement report indicating that a wireless environment in the AD 112 is overwhelmingly more preferable than in the AD 111 (e.g., a measurement result indicating that electric field intensity is preferable, a reception error rate is preferable, or the like) is transmitted, a possibility of generating a network initiated handover to the AD 112 is estimated.

Further, the content of the measurement reports transmitted recently can be evaluated with respect to a history information indicating whether a network initiated handover being actually performed or not, whereby a condition of possible network initiated handover being initiated is estimated. Further, the condition of possible network initiated handover being initiated, which is downloaded from a network or is stored in a SIM card or a memory of the UE 100 beforehand, may be used for the estimation.

Herein, as illustrated in FIG. 19, when the UE 100 has connections to a plurality of PDNs 130 to 132 at the same time, only connections to particular PDNs may be targeted for the handover. For instance, only connections to the PDNs 130, 131 are targeted for handover, and the other connection to the PDN 132 is not subjected to the handover and kept remaining in the current access network. Similarly, only connections with a part of the PDNs are targeted for the network initiated handover. In this case, the UE 100 may perform a UE initiated handover in advance only with respect to the PDNs that are not a target of the network initiated handover. Thereby, the number of PDNs as the target of the UE initiated handover that is performed after the completion of the network initiated handover can be reduced, so that handover time can be reduced in total.

### Embodiment 4

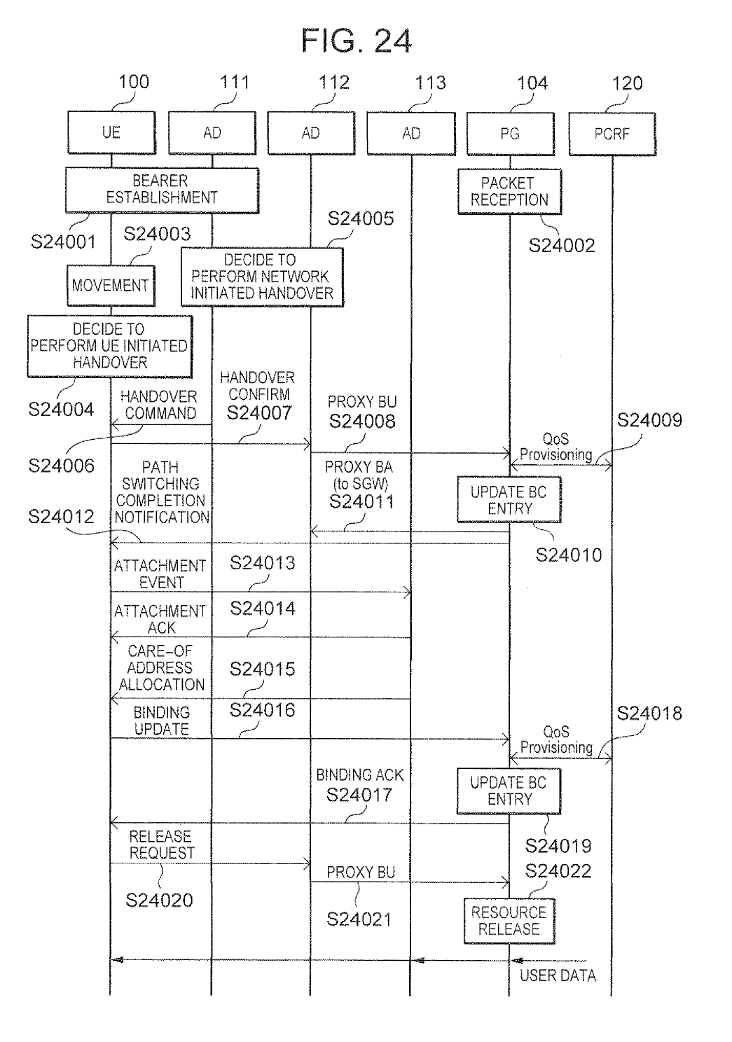

Embodiment 4 of the present invention is described below. A handover processing method in Embodiment 4 is described with reference to FIGS. 1 and 24. The handover processing method of the present embodiment is different from Embodiment 3 in a path switching completion notification message, and is different from the handover processing method of Embodiment 3 in that a mobile terminal can acquire a notification of the completion of path switching due to the network initiated handover directly from a packet gateway (PG).

Assume herein that the UE 100 has completed DSMIP (or Mobile IP) bootstrapping with the PG 104 at the time of the connection with the AD 111, and has acquired an authentication/encryption key to protect binding of a home address and a care-of address, for example. The UE 100 transmits a handover confirmation message with a notification request flag (Step S24007). When receiving a proxy BU with the notification request flag (PBU) (Step S24008), the PG 104 acquires QoS policy information (Step S24009), and after a BC entry updating processing (Step S24010), notices the completion thereof to the UE 100 (Step S24012).

Since the UE 100 can use DSMIP (or Mobile IP), any of messages related to Mobile IP such as Binding Refresh Request, Binding Revocation or Binding Ack is applicable as the path switching completion notification message. Herein, the UE 100 connects with a home link, and is in a state of not conducing binding registration with the PG 104 (corresponding to a home agent of Mobile IP). That is, the PG 104 does not conduct binding management relating to DSMIP (or Mobile IP) of the UE 100. In such a status, transmitting these message guided by the PG 104 is different from a typical operation, and the UE 100 can recognize the completion of data path switching by a network initiated handover along with the simultaneous occurrence of the UE initiated handover and the network initiated handover detected before. Thereby, the completion of data path switching by the network initiated handover can be noticed directly to the UE 100, thus enabling real time notification and leading to reduction in handover time.

An additional flag may be included in the message used for the above notification means as well. For instance, a flag urging handover to a non-3GPP access can be newly provided. Upon the completion of the data path switching due to the network initiated handover, indication is issued explicitly to the UE 100 so that the UE 100 performs a handover to the non-3GPP access and updates its binding information accordingly, whereby a determination processing of the UE 100 can be reduced, and processing efficiency can be improved. Further, a message can be newly specified instead of applying the above-stated messages.

Receiving the notification, the UE 100 performs a UE initiated handover. That is, after establishing a connection with the access network system AD 113 (attachment event (Step S24013) and attachment ack (Step S24014), the UE 100 receives allocation of a care-of address (Step S24015) and performs Binding Update and Binding Ack (Steps S24016, S24017). Thereafter, the UE 100 releases a resource in the AD 112 (Step S24020). Herein, the PG 104 can release the resource in the AD 112.

Note herein that the UE 100 can add a notification request flag in the handover confirmation message and transmit to the PG 104 in another form. That is, immediately before the UE 100 receiving the handover command and transmitting a handover confirmation message, the UE 100 transmits a specific message having a meaning equivalent to the notification request flag to the PG 104. As the specific message, for example, a Deregistration BU message is transmitted. Herein, the notification request flag can be explicitly added in the message transmitted.

Receiving a proxy BU generated as a result of the handover confirmation message the UE 100 transmits immediately afterward as well as the specific message (e.g., Deregistration BU), the PG 104 acquires QoS policy information for the AD 112 from the PCRF 120 (Step S20009), configures the data path directed to the AG 102 (Step S20010), and transmits a proxy BA to the AG 102 (Step S20011). At the same time, instead of transmitting a path switching completion notification message to a mobility management entity MME in the AD 112, the PG 104 transmits a Binding Acknowledge message, for example, as a message having an equivalent meaning directly to the UE 100. Receiving this, the UE 100 detects the completion of the path switching by the network initiated handover, and immediately performs a UE initiated handover. That is, the UE 100 transmits an attachment event as a connection establishment request to the BS 107 (Step S20014).

The following describes a mobile terminal (UE) according to Embodiments 3 and 4 of the present invention. Herein, since the configuration of the mobile terminal is similar to the configuration described in FIG. 12, the following description refers to FIG. 12. Since major elements according to the present invention are a status determination unit 1203 and a handover control unit 1202, the following mainly describes them.

Firstly, the status determination unit 1203 is described. The status determination unit 1203 generates a trigger to transmit a handover confirmation message including a notification request according to the present invention based on the status of a handover initiation and a status of a mobile terminal. More specifically, the status determination unit 1203 detects a network initiated handover performing at the same time with performing of a UE initiated handover based on reception of a handover command, for example.

More specifically, the status determination unit 1203 detects by the following means. One detection method is as follows. About the time when a handover to the AD 113 is decided based on a wireless environment measurement result of the BS 107 in the AD 113 and a handover policy, generation of an inter-base station handover and an inter-RAT (Radio Access Technology) handover is detected in the access network (AD 111) as a handover source. More specifically, detection is conducted with reception of a handover command in FIG. 20 (having the same meaning as the reception of a handover initiation indication transferring (Step S18014) of FIG. 18A).

Another method is as follows. About the time when a handover to the AD 113 is decided based on a wireless environment measurement result of the BS 107 in the AD 113 and a handover policy, detection can be conducted with transmission of a measurement report in the access network AD 111 as the UE initiated handover source, which is determined as induction of a network initiated handover. More specifically, when a measurement report indicating that a wireless environment in the AD 112 is overwhelmingly more preferable than in the AD 111 (e.g., a measurement result indicating that electric field intensity is preferable, a reception error rate is preferable, or the like) is transmitted, a possibility of generating a network initiated handover to the AD 112 is estimated.

Further, the content of the measurement reports transmitted recently can be evaluated with respect to a history information indicating whether a network initiated handover being actually performed or not, whereby a condition of possible network initiated handover being initiated is estimated. Further, the condition of possible network initiated handover being initiated, which is downloaded from a network or is stored in a SIM card or a memory of the UE 100 beforehand, may be used for the estimation.

The following describes the handover control unit 1202. The handover control unit 1202 performs a notification request processing according to the present invention based on information output from the status determination unit 1203. More specifically, when the status determination unit 1203 detects that a UE initiated handover and a network initiated handover performing at the same time, and receiving a notification as such from the status determination unit 1203, the handover control unit 1202 transmits a handover confirmation message according to the present invention in response to a handover command received from the BS 107.

At this time, a flag (notification request flag 2101: Refer to FIG. 21) is added to the handover confirmation message, the flag indicating to transmit a notification when a data path is completed. Thereby, when data path configuration is completed in the PG 104, the UE 100 receives a notification from the above-described means and immediately can perform a UE initiated handover, so that handover time can be reduced.

Herein, a first transmission/reception unit 1205 and a second transmission/reception unit 1206 receive a packet or a message from an external access network and transmit a packet or a message to an external access network, which are for communication with a 3GPP access and for communication with a non-3GPP access, respectively. The first transmission/reception unit 1205 and the second transmission/reception unit 1206 may be one transmission/reception unit. Communication environment measurement units 1204 and 1207 measure a status of wireless communication (e.g., intensity of radio waves received) surrounding the UE 100, which create a report (measurement report) to report the measured wireless communication status if required and transmit it to a network via the transmission/reception units 1205 and 1206 connected therewith. A handover policy 1201 stores information used when the UE 100 performs a handover.

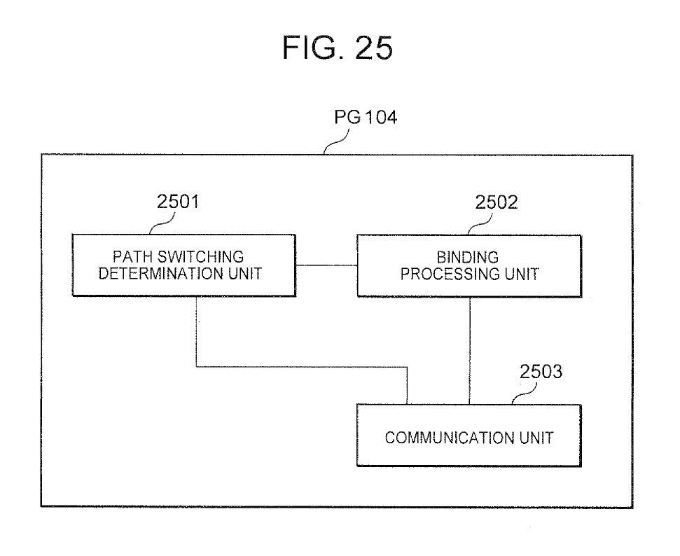

The following describes a packet gateway (PG) according to Embodiments 3 and 4 of the present invention, with reference to FIG. 25. A major element according to the present invention is a path switching determination unit 2501, which is mainly described below.

Receiving, from a binding processing unit 2502, a notification of receiving a proxy BU with a flag (notification request flag 2101: refer to FIG. 21) indicating to transmit a notification when the data path is completed added thereto, the path switching determination unit 2501 monitors the completion of the binding processing by the binding processing unit 2502. Herein, the path switching determination unit 2501 may be interrupted when the binding processing by the binding processing unit 2502 is completed, which can reduce a load for monitoring as compared with the ease where polling is used for the monitoring.

Detecting the completion of the binding processing, the path switching determination unit 2501 implements different operations depending on the embodiments. In the packet gateway 104 of Embodiment 3, the path switching determination unit 2501 generates a path switching completion notification (refer to FIG. 22) transmitted to the UE 100, transfers it to a communication unit 2503, and instructs the communication unit 2503 to transmit the notification to the UE 100 via a MME. Receiving this, the communication unit 2503 transmits the path switching completion notification to the UE 100 via the MME.

In the packet gateway 104 of Embodiment 4, the path switching determination unit 2501 instructs the binding processing unit 2502 to transmit, to the UE 100, a predetermined message among Binding Refresh Request, Binding Revocation and Binding Ack as a message having a similar meaning to the above-stated path switching completion notification. Herein, it can be decided statically beforehand as to whether any of Binding Refresh Request, Binding Revocation and Binding Ack is to be transmitted, whereby a selection processing by the packet gateway can be omitted, so that handover time can be reduced.

Alternatively, it can be decided at the time of transmission as to whether any of Binding Refresh Request, Binding Revocation and Binding Ack is to be transmitted. Thereby, a message can be selected every time depending on the status of the UE 100. For instance, when the UE 100 is performing a connection establishment processing from another access domain and is waiting for the reception of Binding Ack, Binding Refreshment or Binding Revocation is selected so as to avoid confusion. When the UE 100 does not support a Binding Revocation message, messages other than this can be selected dynamically, thus leading to higher efficiency of processing performance.

The binding processing unit 2502 manages a position (address) of the UE 100 in a mobility management protocol such as PMIP or DSMIP. More specifically, receiving a binding update message from the UE 100 or receiving a proxy BU from a MAG of an AD or a serving gateway, the binding processing unit 2502 updates a binding cache entry of the UE 100 to perform switching of a data path.

The communication unit 2503 is for communication with the core network 110 or with the access gateways 101 to 103 of the access domains 111 to 113, which may be a form of wire communication such as Ethernet® or a leased line or a form of wireless communication.

In the present invention, a handover with one base station placed in each access network (access domain) is described in detail. However, a handover with a plurality of base stations and SGWs placed in one access network can be considered similarly. In this case, a network initiated handover is a handover between base stations in a 3GPP access network (AD 111), and a UE initiated handover is a handover between a 3GPP access network (AD 111) and a non-3GPP access network (AD 113).

Each functional block used in the explanations of each embodiment of the present embodiment, described above, can be realized as a large scale integration (LSI) that is typically an integrated circuit. Each functional block can be individually formed into a single chip. Alternatively, some or all of the functional blocks can be included and formed into a single chip. Although referred to here as the LSI, depending on differences in integration, the integrated circuit can be referred to as the integrated circuit (IC), a system LSI, a super LSI, or an ultra LSI. The method of forming the integrated circuit is not limited to LSI and can be actualized by a dedicated circuit or a general-purpose processor. A field programmable gate array (FPGA) that can be programmed after LSI manufacturing or a reconfigurable processor of which connections and settings of the circuit cells within the LSI can be reconfigured can be used. Furthermore, if a technology for forming the integrated circuit that can replace LSI is introduced as a result of the advancement of semiconductor technology or a different derivative technology, the integration of the functional blocks can naturally be performed using the technology. For example, the application of biotechnology is a possibility.

Further, the embodiments of the present invention are described partially on the assumption including a plurality of network interfaces (transmission/reception units 1205, 1206) of a mobile terminal. However, a plurality of logical interfaces may exist to implement the present invention, and as possible configurations for example, one transmission/reception unit may be shared among a plurality of connection methods, which may be switched at a rate whose change can be ignored from aspects of a network interface or a logical link may be maintained at layer 2 so that it can operate in a similar manner to the case where connection is conducted with a network via a plurality of interfaces from a handover control unit or a communication unit at a higher rank than layer 2.

Further, the embodiments of the present invention are on the assumption that the mobile terminal 100 performs wireless communication with a base station via the transmission/reception units 1205 and 1206. However, the mobile terminal may perform wired communication with an access point corresponding to a base station, from which a similar effect can be obtained in the switching between access points.

Moreover, a mobile terminal may be configured with a plurality of communication devices, for example, installing extrapolated or incorporated 3GPP communication device module(s) and non-3GPP communication module(s) into one computer such as a personal computer. In such various mobile terminals also, the present invention can be applied and has the same effect as described above.

As an attachment event or a re-attachment event a mobile terminal transmits, a message used by an authentication system (e.g. AAA system), a message used for a handover (or a fast handover) may be used. Alternatively; a layer 2/3 message such as NAS (Non-Access Stratum) used in cellular communication and a message acquiring an address or configuration information such as DHCP (Dynamic Host Configuration Protocol) may be used, for example.

Although the embodiments of the present invention are described based on the examples of a fixed local mobility environment, the present invention is applicable also to a mobile network environment (or a hierarchical mobile network where a mobile router accommodates a mobile router) configured with mobile routers MRs (and its subordinate nodes). For instance, in NEMO (Network Mobility) as one configuration method of a mobile network, a MR conducts mobility registration of a mobile network (and a terminal) with a home agent, whereby a mobility support to a mobile terminal that the MR accommodates is provided, and a function of a MAG (functionally placed in an access gateway or a Serving-GW) in the present embodiment may be installed in the MR. Further, the case where a network operator providing a network using Proxy MIP uses a multi-stage of tunnels between MAG-LMA (packet gateway or PDN gateway) configuring Proxy MIP corresponds to a hierarchical mobile network.

A network initiated handover may be performed in a non-3GPP access network such as WiMAX, a wireless hotspot, or a wireless LAN network, or during movement between a 3GPP access network and a non-3GPP access network, from which a similar effect can be obtained. Similarly, a UE initiated handover may be performed in a 3GPP access network or in a non-3GPP access network, from which a similar effect can be obtained similarly.

### INDUSTRIAL APPLICABILITY

According to a handover processing method, and a mobile terminal and a connection management device used in the method of the present invention, when detecting a network initiated handover performed at the same time, an indication is issued so as to update a data path again, whereby failures in both handovers are avoided, and communication is enabled via an access network as a UE initiated handover target that is originally optimal. Therefore, the present invention is effective for a handover processing method and a mobile terminal and a connection management device used in the method when a plurality of controlling entities exist to control a handover of a mobile terminal and the handovers of a mobile terminal by the respective controlling entities occur at the same time.

1-23. (canceled)

24. A handover processing method for a mobile terminal, the mobile terminal communicating with a correspondent node via a communication network including a plurality of access networks including first and second access networks in a communication system, a plurality of control entities that control a handover of the mobile terminal existing in the communication system, each control entity performing a handover processing of the mobile terminal, comprising the steps of:
a step where the mobile terminal connecting with the first access network transmits a first connection establishment request message to a base station placed in the second access network, the first connection establishment request message requesting a connection with desired the second access network;
a step where the mobile terminal determines whether a predetermined event occurs or not;
a step where when the mobile terminal determines occurrence of the predetermined event, the mobile terminal generates a second connection establishment request message to the base station in the second access network, the second connection establishment request message including first flag information; and
a step where the mobile terminal transmits the generated second connection establishment request message to the base station in the second access network.

25. A mobile terminal used in a handover processing method for the mobile terminal, the mobile terminal communicating with a correspondent node via a communication network including a plurality of access networks including first and second access networks in a communication system, a plurality of control entities that control a handover of the mobile terminal existing in the communication system, each control entity performing a handover processing of the mobile terminal, comprising:
a message generation means that generates, when connecting with the first access network, a first connection establishment request message requesting a connection with desired the second access network;
a transmission means that transmits the generated first connection establishment request message to a base station placed in the second access network; and
a determination means that determines whether a predetermined event occurs or not,
wherein when it is determined that the predetermined event occurs, the message generation means generates a second connection establishment request message to the base station in the second access network, the second connection establishment request message including first flag information, and
the transmission means transmits the generated second connection establishment request message to the base station in the second access network.

26. The mobile terminal according to claim 25, wherein the predetermined event comprises a network initiated handover processing performed by a predetermined device of the communication network as a control entity before or after transmission of the first connection establishment request message, the network initiated handover processing including a handover processing with another base station in the first access network or a handover processing to a third access network that is other than the first and the second access networks of the plurality of access networks.

27. The mobile terminal according to claim 26, wherein the predetermined event further comprises reception of a connection failure response message conveying a connection failure from the second access network.

28. The mobile terminal according to claim 26, wherein the network initiated handover processing by the predetermined device is detected with occurrence of a handover processing between base stations in the first access network or with occurrence of a handover processing between the first access network and the third access network.

29. The mobile terminal according to claim 26, wherein the network initiated handover processing by the predetermined device is detected with transmission by the mobile terminal of a report to the first access network, the report indicating examination of an access network environment surrounding the mobile terminal.

30. The mobile terminal according to claim 25, wherein the first flag information urges to retransmit, to the base station in the second access network, a path switching message to the second access network.

31. The mobile terminal according to claim 30, wherein the first flag information further urges to use information generated based on the first connection establishment request message received before to process a predetermined processing other than retransmitting of the path switching message to the second access network.

32. The mobile terminal according to claim 25, wherein the message generation means adds second flag information to the first connection establishment request message, the second flag information indicating a predetermined device in the second access network to store information generated based on reception of the first connection establishment request message before transmission of the path switching message to the second access network.

33. The mobile terminal according to claim 32, wherein the generated information comprises information on an authentication processing result of the mobile terminal for connection with the second access network.

34. The mobile terminal according to claim 25, wherein after transmitting the second connection establishment request message to the base station in the second access network and a handover processing is performed to the second access network, when a network initiated handover processing performed by a predetermined device of the communication network as a control entity is performed again,
the message generation means includes third flag information in a second connection establishment request message requesting reconnection with the second access network, and
the transmission means transmits the second connection establishment request message including the third flag information to the base station in the second access network.

35. The mobile terminal according to claim 34, wherein the network initiated handover processing performed again by the predetermined device of the communication network as a control entity is detected with reception of a packet via the first access network.

36. The mobile terminal according to claim 34, wherein the network initiated handover processing performed again by the predetermined device of the communication network as a control entity is detected with reception of a connection failure response message conveying a connection failure a predetermined of times or more from the second access network.

37. The mobile terminal according to claim 34, wherein the third flag information instructs to stop the network initiated handover processing performed by the predetermined device of the communication network as a control entity.

38. The mobile terminal according to claim 34, wherein the transmission means transmits the second connection establishment request message to the predetermined device via a predetermined authentication system.

39. A handover processing method for a mobile terminal, the mobile terminal communicating with a correspondent node via a communication network including a plurality of access networks including first and second access networks in a communication system, a plurality of control entities that control a handover of the mobile terminal existing in the communication system, each control entity performing a handover processing of the mobile terminal, comprising the steps of:
a step where the mobile terminal connecting with the first access network decides to perform handover to desired the second access network;
a step where the mobile terminal determines whether a predetermined event occurs or not;
a step where when the mobile terminal determines occurrence of the predetermined event, the mobile terminal generates a handover confirmation message including flag information;
a step where the mobile terminal transmits the generated handover confirmation message to a base station in the first access network;
a step where the mobile terminal receives a path switching completion notification message from a connection management device performing connection management of the mobile terminal, the path switching completion notification message generated based on the flag information and indicating that a path is switched by a network initiated handover processing that a predetermined device of the communication network performs as a control entity; and
a step where the mobile terminal performs a handover to the second access network based on the path switching completion notification message.
